(19) United States
(12) Patent Application Publication
(10) Pub. No.: US 2019/0222858 A1
(43) Pub. Date: Jul. 18, 2019

(54) OPTIMAL OUT OF LOOP INTER MOTION ESTIMATION WITH MULTIPLE CANDIDATE SUPPORT

(71) Applicant: Intel Corporation, Santa Clara, CA (US)

(72) Inventors: Srinivasan Embar Raghukrishnan, Folsom, CA (US); Jason Tanner, Folsom, CA (US)

(73) Assignee: Intel Corporation, Santa Clara, CA (US)

(21) Appl. No.: 16/365,546

(22) Filed: Mar. 26, 2019

(51) Int. Cl. H04N 19/517; H04N 19/105; H04N 19/137; H04N 19/124; H04N 19/96; H04N 19/176

(52) U.S. Cl. CPC H04N 19/517; H04N 19/105; H04N 19/176; H04N 19/124; H04N 19/96; H04N 19/137

(57) ABSTRACT

Techniques related to coding video using out of loop inter motion estimation are discussed. Such techniques include performing simultaneous motion estimation for multiple blocks using merge candidates such that at least one of the blocks has non-final merge candidates, finalizing the merge candidates for the at least one block, and resolving reference to any non-final merge candidates that became invalid in the finalized merge candidates for final motion estimation.

### BACKGROUND

In video compression/decompression (codec) systems, compression efficiency and video quality are important performance criteria. For example, visual quality is an important aspect of the user experience in many video applications and compression efficiency impacts the amount of memory storage needed to store video files and/or the amount of bandwidth needed to transmit and/or stream video content. A video encoder compresses video information so that more information can be sent over a given bandwidth or stored in a given memory space or the like. The compressed signal or data is then decoded by a decoder that decodes or decompresses the signal or data for display to a user. In most implementations, higher visual quality with greater compression is desirable. Encoder decisions take into account the actual bits required in the bitstream relative to the distortion or error produced. Furthermore, encode techniques may have the continual challenges of minimizing quality loss while breaking encode dependencies for increased throughput and processing efficiency.

It may be advantageous to improve video encode to provide improved compression efficiency and/or video quality. It is with respect to these and other considerations that the present improvements have been needed. Such improvements may become critical as the desire to compress and transmit video data becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is an illustrative diagram of a portion of an example picture of video for video coding;

FIG. 2 is an illustrative diagram of an example system for providing video coding;

FIG. 3 is an illustrative diagram of exemplary unresolved and resolved merge candidates and corresponding exemplary motion estimation records (MERs);

FIG. 4 is a flow diagram illustrating an example process for video coding including out of loop integer motion estimation;

FIG. 5 is a flow diagram illustrating an example process for video coding including out of loop integer motion estimation;

FIG. 6 is a flow diagram illustrating an example process for video coding including out of loop integer motion estimation;

FIG. 7 illustrates an example bitstream;

FIG. 8 illustrates a block diagram of an example encoder for performing out of loop motion estimation;

FIG. 9 is a flow diagram illustrating an example process for video coding including out of loop motion estimation;

FIG. 10 is an illustrative diagram of an example system for video coding including out of loop motion estimation;

FIG. 11 is an illustrative diagram of an example system; and

FIG. 12 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Furthermore, when a particular feature, structure, or characteristic is described in connection with an embodiment, it is submitted that it is within the knowledge of one skilled in the art to effect such feature, structure, or characteristic in connection with other implementations whether or not explicitly described herein. The terms “substantially,” “close,” “approximately,” “near,” and “about,” generally refer to being within +/−10% of a target value. The terms “compares favorably” when used in reference to a threshold indicates the value in question is greater than or greater than or equal to the threshold. Similarly, the terms “compares unfavorably” when used in reference to a threshold indicates the value in question is less than or less than or equal to the threshold.

Methods, devices, apparatuses, computing platforms, and articles are described herein related to video coding and, in particular, to out of loop inter motion estimation with multiple candidate support for improved coding efficiency and quality.

As discussed above, in some video coding contexts, encoder decisions take into account the actual bits (or an proxy estimate of the bits) required in the bitstream relative to the distortion or error produced due to the coding. Furthermore, a key component of video compression is the temporal prediction from past or future pictures for the current picture being encoded such that the prediction has an associated motion vector (or motion vectors) that point to different locations of past or future pictures. A motion vector may be determined using motion vector search including an integer motion estimation and a fractional motion estimation such that the fractional motion estimation is a refinement of the integer motion estimation and is typically limited to a half pel, quarter pel, and an eighth pel around an integer location. An ongoing challenge with video coding results from coding dependencies that require coding decisions to be fully made for portions of a picture before coding mode decisions can be made for other portions. For example, inter motion estimation for a particular block or unit may be delayed until inter motion estimation and/or coding mode decisions are made for another block or unit to derive the delta motion vector distance for the bit cost estimate. Such techniques may be characterized as in loop as dependencies between blocks are maintained (and processing waits until neighboring blocks are resolved).

The techniques discussed herein advantageously break some such dependencies while maintaining coding quality (in terms of compression and subjective and objective video quality). Such techniques are characterized as out of loop as such dependencies are at least partially broken. Notably, the discussed techniques do not wait for prior blocks to fully derive their motion vectors and instead perform motion estimation in parallel for such blocks. Furthermore, the simultaneous motion estimation uses non-final but predictive candidate motion vectors (e.g., merge candidates) for the motion estimation of some of the blocks. The motion estimation is adjusted, as discussed herein, due to non-final merge candidates being invalidated by storing multiple motion estimation records, by adjusting such records, and so on. Subsequently, as motion vectors for the blocks are resolved, the out of loop motion estimation search results are adjusted. Notably, the non-final merge candidates are then known to be final or unavailable for the motion estimated block. If the non-final merge candidate becomes final, it may be used as a valid motion estimation result.

If the non-final merge candidate is not in the final merge candidates (e.g., it is not available and is therefore discarded), in some embodiments, a secondary motion estimation record may be used. For example, the secondary motion estimation record may reference a different motion vector that may be valid. In some embodiments, the motion vector referenced by the secondary motion estimation record may also become a non-final merge candidate (e.g., no restriction is provided that the secondary motion estimation record reference a known valid motion vector). If so, it may also be discarded. However, it has been found that the likelihood of one of the primary or secondary motion estimation records referencing a valid merge candidate and the coding efficiency of storing two such records provides for increased throughput and high quality coding. That is, it strikes a balance between breaking the discussed coding dependencies and coding quality (as compared, for example, to an exhaustive fully dependent in loop motion estimation).

In addition or in the alternative, when the non-final merge candidate(s) are not in the final merge candidates for a block (and therefore are not available at the decoder), a closest valid or final merge candidate may be found relative to the referenced merge candidate motion vector. The closest final merge candidate may be determined, for example, based on a smallest delta between the final merge candidate and the non-final merge candidate (which is now known to be invalid) determined by differencing, sums of squares of differences, etc. The difference measurement between the final merge candidate and the non-final merge candidate may then be compared to a threshold and, if the measurement compares favorably to the threshold, the closest final merge candidate may be used. If not, the closest final merge candidate may be discarded.

In other embodiments, denoting a block of interest of a first block, such that the merge candidates for the first block reference motion vectors of a second neighboring block, for which parallel motion estimation has been performed, and motion vectors of a third block that neighbors the second block but not the first (and which had motion estimation previously performed), a non-final merge candidate from the third block may be referenced for the first block and then become invalid as discussed. In such contexts, a difference measurement for a final motion vector for the third block and a final motion vector for the second block may be determined and, if the difference compares favorably to a threshold, a motion estimation record that references a merge candidate from the third block is used, and, if not, the motion estimation record is discarded.

Thereby, one or more motion estimation records for a block are generated by performing motion estimation for the block using non-final merge candidates and in parallel with other blocks—some of which have only known final merge candidates, some of which have final and non-final merge candidates, and some of which have only non-final merge candidates—and resolving the non-final merge candidates as discussed. Subsequently, the selected motion vector for the block, which references a now known final merge candidate, may be refined using fractional motion estimation and/or compared to other coding modes (e.g., intra) and a final mode decision may be made for the block. The block is then coded using the coding mode and relevant corresponding data into a bitstream. The discussed techniques have low quality impacts relative to fully dependent exhaustive searching techniques while improving coding efficiency.

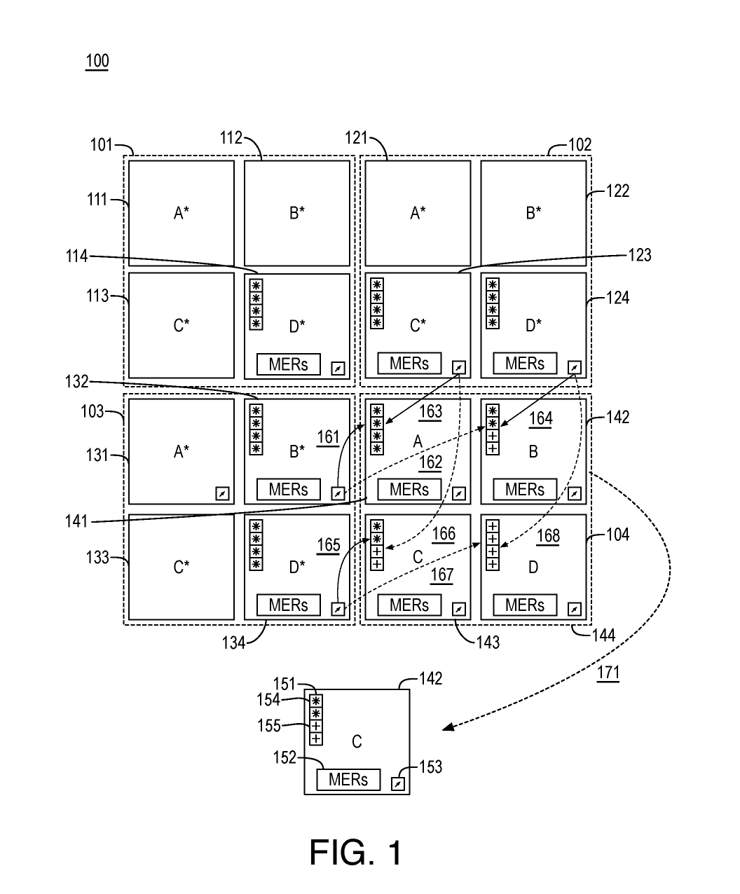

FIG. 1 is an illustrative diagram of a portion of an example picture of video 100 for video coding, arranged in accordance with at least some implementations of the present disclosure. As shown in FIG. 1, picture of video 100 may be divided into blocks 101, 102, 103, 104, which may be further divided, respectively, into blocks including blocks 111, 112, 113, 114 of block 101, blocks 121, 122, 123, 124 of block 102, blocks 131, 132, 133, 134 of block 103, and blocks 141, 142, 143, 144 of block 104. In the context of FIG. 1, discussion pertains to the coding of blocks 141, 142, 143, 144 of block 104. Notably, blocks labeled with an asterisk (e.g., A*, B*, etc.) have been resolved in the sense that motion estimation and final mode decisions have been performed for such blocks. Therefore, final motion vectors (if applicable) are available for such blocks during encode of blocks 141, 142, 143, 144 of block 104. Blocks labeled without an asterisk (e.g., A, B, etc.) are the subject of coding and have not yet been resolved. In some embodiments, blocks 101, 102, 103, 104 are coding tree units and blocks 131, 132, 133, 134 are coding units. However, any coding structure may be used with respect to picture of video 100.

Picture of video 100 may be any picture of a video sequence that is being coded using motion estimation techniques. Such video may include any suitable video frames, video pictures, sequence of video frames, group of pictures, groups of pictures, video data, or the like in any suitable resolution. For example, the video may be video graphics array (VGA), high definition (HD), Full-HD (e.g., 1080p), or 4K resolution video, or the like, and the video may include any number of video frames, sequences of video frames, pictures, groups of pictures, or the like. Techniques discussed herein are discussed with respect to pictures, blocks, and sub-blocks having various shapes for the sake of clarity of presentation. As used herein, a block may be any size and shape such that it includes a plurality of pixel samples (typically square or rectangular) in any suitable color space such as YUV. Furthermore a block may have sub-blocks, which also may be characterized as blocks herein. However, such pictures may be characterized as frames, video pictures, sequences of pictures, video sequences, etc., such blocks may be characterized as largest coding units, coding units, coding blocks, macroblocks, sub-units, sub-blocks, etc. For example, a picture or frame of color video data may include a luminance plane or component and two chrominance planes or components at the same or different resolutions with respect to the luminance plane. The video may include pictures or frames that may be divided into blocks of any size, which contain data corresponding to blocks of pixels. Such blocks may include data from one or more planes or color channels of pixel data. For example, a block may be a prediction block or a partition. In the context of the High Efficiency Video Coding (HEVC), the HEVC standard defines a coding tree unit (CTU) for a picture (e.g., a video frame of a video sequence) that may be partitioned into coding units (CUs) that take the form of rectangular blocks having variable sizes. Such coding units may be used as the basic unit or block for intra coding. However, as discussed, the block of video data may include any block of video data and any coding standard may be used.

With reference to block 142, which is also shown separately via view 171 for the sake of clarity, during motion estimation of any block, the block may use or have available thereto merge candidates 151, which may also be characterized as a merge candidate list. Merge candidates 151 provides a list of motion vectors that may be referenced during inter coding of block 142. For example, each motion vector of merge candidates 151 may provide a cost center against which motion vectors for block 142 are scored. For example, for a particular shape of a sub-block of block 142, potential motion vectors may be scored according to their cost against each of merge candidates 151 such that the cost (e.g., a distortion) includes a picture distortion cost of the potential motion vector and a difference cost relative to a merge candidate. That is, both the picture distortion and the delta from the merge candidate are costly in terms of rate distortion optimization and both are taken into account in generating a resultant motion estimation result for block 142 (and other blocks of block 104).

Notably, merge candidates 151 include final merge candidates 154 (indicated using a star or asterisk) and non-final merge candidates 155 (indicated using a plus sign), where the terms final and non-final are relative to block 142. As used herein, a final merge candidate is a merge candidate that is known to be valid at the time of motion estimation for a particular block and a non-final merge candidate is a merge candidate that is not known to be valid at the time of motion estimation for a particular block, and may therefore become invalid. A merge candidate may be final for one block while being non-final for another block. For example, a merge candidate from block 132 is a final merge candidate for block 141 but not for block 142.

For example, as shown with respect to block 142, merge candidates 151 may include one or more candidates from block 124 (i.e., final merge candidates 154) via merge candidate transfer 164 such that, since block 124 has been previously resolved, such merge candidates are final and known prior to motion estimation of block 142 (which is discussed further herein) and such that final merge candidates 154 cannot be invalidated. Merge candidate transfers of final merge candidates are illustrated with solid lines. Alternatively, as also shown with respect to block 142, merge candidates 151 may include one or more candidates from block 132 (i.e., non-final merge candidates 155) via merge candidate transfer 162 such that, since block 141 has not been previously resolved, such merge candidates are non-final prior to motion estimation of block 142 and such that non-final merge candidates 155 may later be invalidated. Merge candidate transfers of non-final merge candidates are illustrated with dashed lines.

For picture of video 100, a video coder system may perform top down and left to right processing (e.g., in a raster scan order or similar order) based on block size starting with larger blocks and progressing to smaller blocks. For example, blocks 101, 102, 103, 104 may be 64×64 blocks (e.g., CTUs) that are processed in the order of blocks 101, 102, 103, 104 or a similar order such that, in any event, blocks 101, 102, 103 are processed (e.g., resolved) prior to the processing of block 104. Processing of block 104 may then proceed beginning with the largest block thereof, progressing through medium sized blocks (and shapes) and ending with the smallest blocks (and shapes). For example, processing of block 104 may be processed in an order of 64×64 block 104, 32×32 block 141, a top left 16×16 block within block 141, an 8×8 top left block within that 16×16 block, an 8×8 top right block within that 16×16 block (e.g., assuming 8×8 is the smallest block being evaluated), an 8×8 bottom left block within that 16×16 block, a bottom right block within that 16×16 block, moving to the top right 16×16 block within block 141, and so on. Notably, although discussed with respect to only square blocks, other block shapes such as rectangular block shapes may also be used. For example, motion estimation (e.g., integer motion estimation discussed herein) may perform 32×32 block searches, 16×16 block searches, down to 8×8 block searches as discussed.

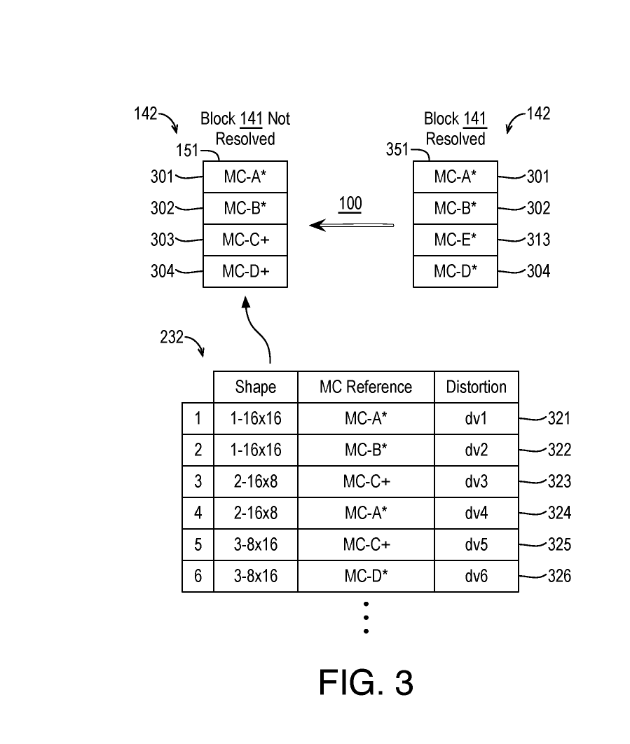

For some or all such searches, that is, for some or all of such evaluated sub-block or shapes that are searched, a motion estimation record of motion estimation records (MERs) 152 stores each shape, a corresponding distortion, and a corresponding referenced motion vector from merge candidates 151. Such motion estimation records 152 are discussed further with respect to FIG. 3 and elsewhere herein. Also as shown with respect to block 142 (and as applies to other blocks herein), after resolving the block, one or more final motion vectors 153 are determined for the block (e.g., relative to a final mode decision including partitioning, if applicable, of block 142 and the final motion vector(s) for each of the partition(s)). Such merge candidates 151, motion estimation records 152, and final motion vectors 153 for each block of picture of video 100 are not labeled for the sake of clarity of presentation. Such final motion vectors 153 (after they are resolved) of blocks of picture of video 100 are used for coding of the block and become merge candidates for subsequent neighboring blocks. That is, once the final motion vector(s) of block 141 are resolved, they partially define the final merge candidates of block 142 and block 143.

Although illustrated and discussed with respect to processing of blocks 141, 142, 143, 144 with respect to other blocks of the same size, it is noted that the same techniques and principles may be applied to smaller sub-blocks and shapes of each of blocks 141, 142, 143, 144. Notably, such processing may be performed at any or all block size and shape levels. Discussion now turns to the parallel processing of blocks 141, 142, 143, 144 of block 104. Notably, motion estimation of such blocks using only final motion vectors to define merge candidates would be highly serial and dependent processing that limits coding throughput. The parallel processing techniques discussed herein break such dependencies for improved coding efficiency.

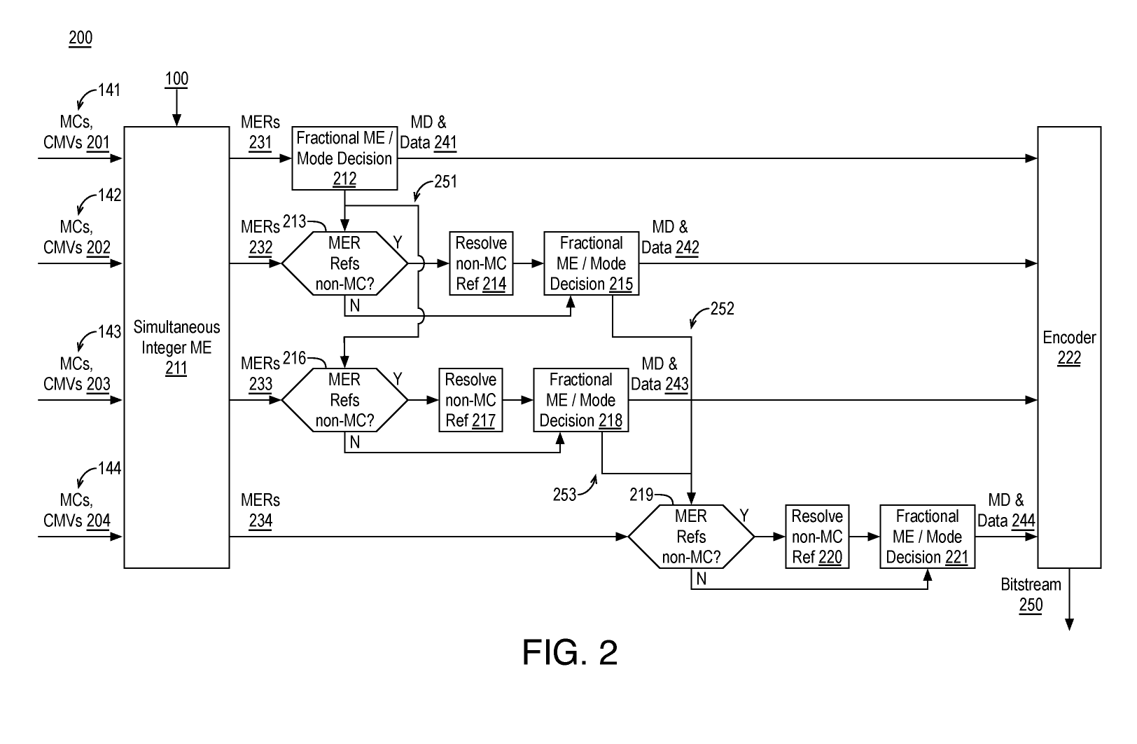

FIG. 2 is an illustrative diagram of an example system 200 for providing video coding, arranged in accordance with at least some implementations of the present disclosure. As shown in FIG. 2, system 200 includes a simultaneous integer motion estimation (ME) module 211, a fractional ME and final mode decision module 212, a ME records (MER) evaluation module 213, a resolution module 214 for resolving non-merge candidate references detected by MERs evaluation module 213, a fractional ME and final mode decision module 215, a MERs evaluation module 216, a resolution module 217 for resolving non-merge candidate references detected by MERs evaluation module 216, a fractional ME and final mode decision module 218, a MERs evaluation module 219, a resolution module 220 for resolving non-merge candidate references detected by MERs evaluation module 219, a fractional ME and final mode decision module 221, and an encoder 222.

System 200 provides video compression and system 200 may be a portion of a video encoder implemented via a computer or computing device or the like. For example, system 200 receives video data and generates a bitstream 250 that may be decoded by a decoder to generate a decompressed version of the video data. Bitstream 250 may be compatible with a video compression-decompression (codec) standard, for example, such as HEVC, or the like. System 200 may be implemented via any suitable device such as, for example, a personal computer, a laptop computer, a tablet, a phablet, a smart phone, a digital camera, a gaming console, a wearable device, a display device, an all-in-one device, a two-in-one device, or the like or platform such as a mobile platform or the like. For example, as used herein, a system, device, computer, or computing device may include any such device or platform.

System 200 may include other modules not shown for the sake of clarity of presentation. For example, system 200 may include a transform module, an intra prediction module, a motion compensation module, a reference picture buffer, a scanning module, an entropy encoder, etc., some of which are discussed herein with respect to FIG. 8. In some embodiments, system 200 includes a local decode loop for generating reference pictures or frames used in the encoding process. Such modules are known to those of skill in the art and are not discussed further herein for the sake of clarity in presentation.

As shown, simultaneous integer ME module 211 receives picture of video 100 and merge candidates (MCs) and candidate motion vectors (CMVs) 201 corresponding to block 141, MCs and CMVs 202 corresponding to block 142, MCs and CMVs 203 corresponding to block 143, and MCs and CMVs 204 corresponding to block 144. The candidate motion vectors may include any suitable candidate motion vectors for evaluation such as a zero motion vector, motion vectors generated using hierarchical motion estimation (HME) techniques, motion vectors from collocated blocks of one or more reference frames, etc. In an embodiment, in addition to or as an alternative to candidate motion vectors, a predefined search of preselected motion vectors is performed. Simultaneous integer ME module 211 performs simultaneous or in parallel motion estimation for each of blocks 141, 142, 143, 144. As used herein, the terms simultaneous or in parallel in reference to motion estimation indicate the motion estimation is performed at least partially at the same time and such that results from one block of the blocks being simultaneously processed cannot influence results from another block. Although discussed with respect to integer ME, in some embodiments, fractional ME may be implemented. For example, the fractional ME may be limited to half pel, quarter pel, and three quarter pel around integer locations. In some embodiments, blocks 101, 102, 103, 104 are coding tree units, blocks 131, 132, 133, 134 are coding units, and performing simultaneous motion estimation for blocks 101, 102, 103, 104 (coding units) is in response to full coding mode selection completion of one or all of blocks 101, 102, 103 (e.g., prior coding tree units in a coding flow).

With reference to FIG. 1, motion estimation is performed for blocks 141, 142, 143, 144 simultaneously. In a final coding, block 141 depends from blocks 123, 132, block 142 depends from blocks 124, 141, block 143 depends from blocks 141, 134, and block 144 depends from blocks 142, 143 for the purposes of merge candidate motion vectors. That is, the final motion vector result for the top and left blocks of a particular block at least partially define the final merge candidates that are valid (e.g., useable at the decoder) for a particular block. Maintaining such dependencies would require serial processing of blocks 141, 142, 143, 144.

Instead, as shown, motion estimation for block 141 is performed with a fully final candidate list while motion estimation for blocks 142, 143, 144 is performed with candidate lists that may include a mix of final merge candidates and non-final merge candidates. For example, the merge candidates of block 141 are attained via merge candidate transfer 161 from block 132 and merge candidate transfer 163 from block 123 (and optionally a merge candidate transfer from block 114). That is, block 141 only depends from previously resolved blocks and, therefore, the merge candidates of block 141 are characterized as final.

In contrast, motion estimation for block 142 is performed with a merge candidate list that is at least partially non-final. For example, the merge candidates of block 142 are attained via merge candidate transfer 164 from block 124 (which provides final merge candidates with respect to block 142) and merge candidate transfer 162 from block 132 (which are non-final with respect to block 142 since they do not come from the final results of block 141). That is, since final merge candidates are not available from block 141, non-final merge candidates (or predictive merge candidates), relative to block 142, are used for motion estimation of block 142.

Similarly, motion estimation for block 143 is performed with a merge candidate list that is at least partially non-final. The merge candidates of block 143 are attained via merge candidate transfer 165 from block 134 (which provides final merge candidates with respect to block 143) and merge candidate transfer 166 from block 123 (which are non-final with respect to block 142 since they do not come from the final results of block 141). That is, since final merge candidates are not available from block 141, non-final merge candidates, relative to block 143, are used for motion estimation of block 143.

Lastly, motion estimation for block 144 is performed with a merge candidate list that is also at least partially non-final. The merge candidates of block 144 are attained via merge candidate transfer 168 from block 124 (which provides non-final merge candidates with respect to block 144 since they do not come from the final results of block 142) and merge candidate transfer 167 from block 134 (which are non-final with respect to block 144 since they do not come from the final results of block 143). That is, since final merge candidates are not available from blocks 142, 143 (and optionally block 141), non-final merge candidates, relative to those blocks are used for motion estimation of block 144.

Returning to FIG. 2, as shown, motion estimation records (MERs) 231 relative to block 141, MERs 232 relative to block 142, MERs 233 relative to block 143, and MERs 234 relative to block 144 are determined and stored to memory. Such MERs may be generated using any suitable technique or techniques such as motion estimation searching (e.g., integer motion estimation searching) of a particular support window around candidate motion vectors and/or other motion vectors for particular shapes of blocks 141, 142, 143, 144 and scoring of the cost of each searched motion vector for each shape to determine one or more MERs for each shape. In an embodiment, for each shape (e.g., 16×16 blocks, 16×8 blocks, 8×16 blocks, 8×8 blocks, etc.) a motion estimation record is maintained. In some embodiments, for each shape, multiple motion estimation record are maintained as is discussed further herein.

Notably, MERs 231 relative to block 141 are final (in that they did not use any non-final merge candidates). MERs 231 may then be used by fractional ME and final mode decision module 212 to generate a mode decision and corresponding data 241. Fractional ME and final mode decision module 212 may generate mode decision (MD) and corresponding data 241 using any suitable technique or techniques such as rate distortion optimization operations or the like. For example, mode decision and corresponding data 241 may include, for block 141, a partitioning of block 141, a motion vector and reference picture(s) for each partition (if inter prediction is selected) or an intra mode for the block. For example, mode decision and corresponding data 241, 242, 243, 244 include final mode decisions for their corresponding blocks. It is noted that MERs 231, 232, 233, 234 may include or be used to determine mode decisions that are not final and are only based on integer motion estimation. As shown, the resultant MD and corresponding data 241 are provided to encoder 222, which codes block 141 using MD and corresponding data 241 to generate a portion of bitstream 250. For example, encoder 222 may generate a reconstructed block corresponding to block 141 using MD and corresponding data 241 via a local decode loop, difference the reconstructed block with block 141 to generate residuals, transform and quantize the residuals, and entropy encode the transformed and quantized residuals into bitstream 250.

Furthermore, MD and corresponding data 241, or a relevant portion thereof are provided to MERs evaluation module 213 and MERs evaluation module 216. For example, MD and corresponding data 241 include relevant merge candidate information for blocks 142, 143. That is, MD and corresponding data 241 may be used to finalize the merge candidates of blocks 142, 143 as the final motion vector information for block 141 is resolved by fractional ME and final mode decision module 212. For example, fractional ME and final mode decision module 212 may perform fractional ME to generate one or more final motion vectors for block 141, which are, in turn final merge candidates for blocks 142, 142.

As shown, MERs evaluation module 213 receives at least a portion of MD and corresponding data 241 and MERs 232 relative to block 142. As discussed, MERs 232 were generated using one or more merge candidates that were non-final relative to block 142. In this respect, MD and corresponding data 241 includes information that may finalize the merge candidates for block 142. MERs evaluation module 213 determines whether any of MERs 232 reference a merge candidate of MCs and CMVs 202 that has been now determined to be invalid. If not, processing of MERs 232 bypasses resolution module 214 and processing continues with use of MERs 232 by fractional ME and final mode decision module 215 to generate MD and corresponding data 242 for block 142 as discussed with respect to fractional ME and final mode decision module 215, which may in turn be used to encode block 142 by encoder 222 as discussed with respect to block 141.

If MERs evaluation module 213 determines one or more of MERs 232 reference a merge candidate of MCs and CMVs 202 that has been now determined to be invalid, processing continues at resolution module 214 where the references to the now invalid merge candidates are resolved using any techniques discussed herein to generate redefined MERs or other data for use by fractional ME and final mode decision module 215 to generate MD and corresponding data 242 for block 142, which is then used to encode block 142 by encoder 222 as discussed with respect to block 141.

FIG. 3 is an illustrative diagram of exemplary unresolved and resolved merge candidates and corresponding exemplary motion estimation records (MERs), arranged in accordance with at least some implementations of the present disclosure. As shown in FIG. 3, merge candidates 151 for block 142, prior to motion estimation by simultaneous integer ME module 211 (and prior to block 141 being resolved—having a final motion estimation motion vector or mode decision), may include any number (the example of FIG. 3 has four entries, but any number may be used) motion vector merge candidates 301, 302, 303, 304, which are labeled as merge candidates MC-A*, MC-B*, MC-C+, and MC-D+ where an asterisk indicates the merge candidate is final relative to block 142 (e.g., it is known to be valid) and a plus indicates the merge candidate is non-final and may, after resolution of block 141, for example, be deemed to be invalid. For example, merge candidates 303, 304 (MC-C+, MC-D+) may be received via merge candidate transfer 162 from block 161 and merge candidates 301, 302 (MC-A*, MC-B*) may be received via candidate transfer 164 from block 124.

For example, as shown with respect to final merge candidates 351 for block 142, after resolution of block 141, merge candidates 301, 302 (MC-A*, MC-B*) remain as they were known final merge candidates with respect to block 142. Furthermore, merge candidate 304, after resolution of block 141, has been validated as a final merge candidate relative to block 142 due to the resolution of block 141 including the motion vector of merge candidate 304. Therefore, merge candidate 304 is changed from non-final (MC-D+) to final (MC-D*). Also as shown, merge candidate 303, after resolution of block 141, has been invalidated as a final merge candidate relative to block 142 due to the resolution of block 141 not including the motion vector of merge candidate 303. Therefore, merge candidate 303 is discarded and replaced by a different final merge candidate 313 (MC-E*).

Notably, for any entry of MERs 232 that references merge candidates 301, 302, 304, no change is needed as the merge candidate has remained valid or become validated as a final merge candidate. However, any entry of MERs 232 that references merge candidate 303, resolution in some manner is needed as the merge candidate is no longer valid. Such resolution may be made by resolution module 214 using any suitable technique or techniques discussed herein.

In an embodiment, in order to reduce the chances of MERs 232 including entries for a shape such that all entries of the shape reference invalidated merge candidates, simultaneous integer ME module 211 may generate, for each shape of block 142 that is evaluated, multiple entries for each shape. That is, instead of a single entry to MERs 232, each shape would have more than one entry with two entries being particularly advantageous. Notably, indication may not be made to simultaneous integer ME module 211 as to which merge candidates of merge candidates 151 are valid and which are at risk. Instead, the use of multiple entries per shape (with each entry necessarily referencing different merge candidates) may provide a higher probability that a subsequently valid merge candidate is referenced for each shape while maintaining processing efficiency.

For example, as shown, MERs 232 may include any number of entries 321, 322, 323, 324, 325, 326 such that each shape has multiple entries. As shown, shape 1 (a particular 16×16 block) has entries 321, 322. Entry 321 includes shape 1, a reference merge candidate MC-A*, and a distortion value dv1 such that dv1 is the lowest available distortion value for shape 1. As discussed, the distortion values may include a picture based distortion (e.g., a comparison of shape 1 in picture of video 100 to shape 1 in the relevant reference picture(s) using a sum of squares distortion or the like) summed with a motion vector coding cost distortion (e.g., a delta between the reference merge candidate MC-A* and the actual resultant motion vector for shape 1—which may also be stored as a delta MV in entry 321). Furthermore, entry 322, which makes an entry pair with entry 321, includes shape 1, a reference merge candidate MC-B*, and a distortion value dv2 such that dv1 is the lowest available distortion value for shape 1 that does not reference merge candidate MC-A*. That is, the primary entry for each shape in MERs 232 is selected such that the reference merge candidate corresponds to the lowest available distortion value for the shape. The secondary entry for each shape in MERs 232 is selected such that the reference merge candidate corresponds to the lowest available distortion value for the shape with the reference merge candidate being excluded from the distortion evaluation. Notably, entries allowed to use only the lowest available distortion values in order may use the same merge candidates, which would not aid in having an entry that supports the primary merge candidate being invalidated.

Similarly, entry 323 includes shape 2, a reference merge candidate MC-C+, and a distortion value dv3 such that dv3 is the lowest available distortion value for shape 2. Entry 324, which makes an entry pair with entry 323, includes shape 2, a reference merge candidate MC-A*, and a distortion value dv4 such that dv4 is the lowest available distortion value for shape 2 excluding reference to merge candidate MC-C+. Finally, entry 325 includes shape 3, a reference merge candidate MC-C+, and a distortion value dv5 such that dv5 is the lowest available distortion value for shape 3. Entry 326, which makes an entry pair with entry 325, includes shape 3, a reference merge candidate MC-D+, and a distortion value dv6 that is the lowest available distortion value for shape 3 exclusive of reference to merge candidate MC-C+. As shown, MERs 232 may include any number of such entries such as 120 entries for 60 available shapes of sub-blocks of block 142. As discussed, simultaneous integer ME module 211 may generate MERs 232 having such multiple entries.

Returning to FIG. 2, in some embodiments, when MERs evaluation module 213 determines a primary shape entry (e.g., entry 321, 323, 325) reference a merge candidate of MCs and CMVs 202 that has been now determined to be invalid, resolution module 214 attempts to select a secondary shape entry (e.g., entry 322, 324, 326) for the shape. If the secondary shape entry is used, it replaces the primary shape entry and the primary shape entry is discarded. If both the primary and secondary (or more) shape entries reference merge candidates that are no longer valid, processing may continue without a merge candidate for the particular shape or other resolution techniques as discussed herein may be used. In some embodiments, such an instance may be handled by discarding the shape from consideration or by re-performing integer motion estimation for the shape.

With reference to FIG. 3, for primary entry 321, MERs evaluation module 213 determines, using MD and corresponding data 241, that merge candidate reference MC-A* is valid (e.g., is in final merge candidates 351) and primary entry 321 is used (e.g., secondary entry 322 is discarded). For primary entry 323, MERs evaluation module 213 determines, using MD and corresponding data 241, that merge candidate reference MC-C+ is invalid (e.g., is not in final merge candidates 351) and primary entry 323 is discarded and/or replaced with secondary entry 324 by resolution module 214. Notably, secondary entry 324 references merge candidate MC-A*, which is valid and may be used. Similarly, for primary entry 325, MERs evaluation module 213 determines, using MD and corresponding data 241, that merge candidate reference MC-C+ is again invalid (e.g., is not in final merge candidates 351) and primary entry 325 is discarded and/or replaced with secondary entry 326 by resolution module 214 such that secondary entry 326 references merge candidate MC-D*, which is valid and may be used.

Thereby, updated MERs data relative to block 142 are provided to fractional ME and final mode decision module 215 to generate a mode decision and corresponding data 244 using the techniques discussed with respect to fractional ME and final mode decision module 215. The resultant MD and corresponding data 243 are provided to encoder 222, which codes block 142 using MD and corresponding data 242 to generate a portion of bitstream 250.

Furthermore, MERs evaluation module 216 receives at least a portion of MD and corresponding data 241 and MERs 233 relative to block 143. As with MERs 232, MERs 233 were generated using one or more merge candidates that were non-final relative to block 143. MERs evaluation module 216 determines whether any of MERs 233 reference a merge candidate of MCs and CMVs 203 that has been now determined to be invalid. If not, processing of MERs 233 bypasses resolution module 217 and processing continues with use of MERs 233 by fractional ME and final mode decision module 218 to generate MD and corresponding data 243. If so, processing continues at resolution module 217 where the references to the now invalid merge candidates are resolved using any techniques discussed herein to generate redefined MERs or other data for use by fractional ME and final mode decision module 218 to generate MD and corresponding data 243 for block 143, which is then used to encode block 143 by encoder 222.

Similarly, MERs evaluation module 219 receives at least portions of MD and corresponding data 242, 243 and MERs 234 relative to block 144. MERs 234 were generated using one or more merge candidates that were non-final relative to block 144. MERs evaluation module 219 determines whether any of MERs 234 reference a merge candidate of MCs and CMVs 204 that has been now determined to be invalid. If not, processing of MERs 234 bypasses resolution module 220 and processing continues with use of MERs 234 by fractional ME and final mode decision module 221 to generate MD and corresponding data 244. If so, processing continues at resolution module 220 where the references to the now invalid merge candidates are resolved using any techniques discussed herein to generate redefined MERs or other data for use by fractional ME and final mode decision module 221 to generate MD and corresponding data 244 for block 144, which is then used to encode block 144 by encoder 222.

Notably, MERs evaluation modules 216, 219, resolution modules 217, 220, and fractional ME and final mode decision modules 218, 221 may perform any operations discussed herein with respect to MERs evaluation module 213, resolution module 214, and fractional ME and final mode decision module 215. Such operations will not be repeated for the sake of brevity. With reference to FIG. 1, it is noted that processing of blocks 142, 143 may be impacted by the completion of processing of block 141 while processing of block 144 may be impacted by the completion of processing of blocks 142, 143 in a cascading manner. However, resolution of such dependencies is of low complexity in comparison to the breaking of such dependencies for integer motion estimation searching and evaluation due to the complexity of such search (e.g., in terms of shapes evaluated, search ranges, distortion calculations, etc.).

As discussed, in some embodiments, resolving invalidated merge candidates involves attaining multiple MERs for each shape. Such resolved merge candidates are used to determine MD and corresponding data 241, 242, 243, 244, which in turn is used to encode blocks 101, 102, 103, 104 into bitstream 250. Discussion now turns to other embodiments for handling or resolving such invalidated merge candidates. It is noted that such determination of MD and corresponding data 241, 242, 243, 244 and its use encode blocks 101, 102, 103, 104 into bitstream 250 may be performed in the context of any resolved merge candidates and motion estimation discussed herein.

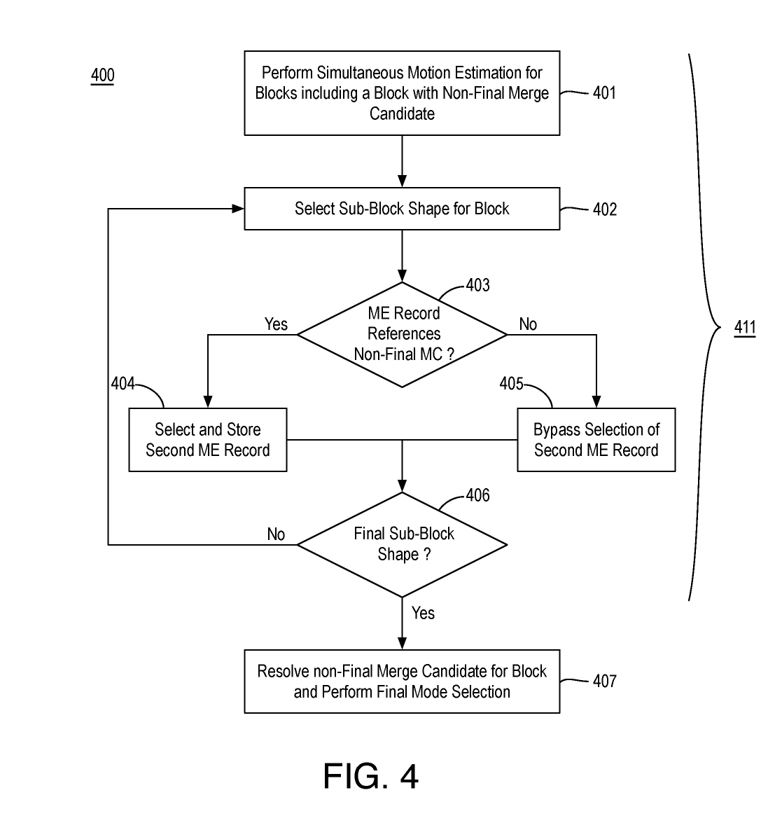

FIG. 4 is a flow diagram illustrating an example process 400 for video coding including out of loop integer motion estimation, arranged in accordance with at least some implementations of the present disclosure. Process 400 may include one or more operations 401-407 as illustrated in FIG. 4. Process 400 may be performed by a device (e.g., system 200 as discussed herein) to input video into a bitstream.

Process 400 begins at operation 401, where simultaneous motion estimation is performed by simultaneous integer ME module 211 for blocks 141, 142, 143, 144 as discussed herein to generate MERs 231, 232, 233, 234. As shown by shared operations indicator 411, operations 401—may be performed during such simultaneous motion estimation to generate MERs 231, 232, 233, 234.

Processing continues at operation 402, where a sub-block shape of any of blocks 142, 143, 144 is selected (the processing provided by operations 402-406 is not needed for block 141 as all merge candidates are known to be valid). Processing continues at decision operation 403, where a determination is made as to whether the primary entry for the shape, such as any of primary entries 321, 323, 325, references a candidate motion vector that is non-final. For example, each of merge candidates 151 may be tagged with a corresponding bit that indicates whether the merge candidate is final merge candidate or a non-final merge candidate. For example, merge candidate 301 may be tagged with a bit of 1 to indicate it is final (as indicated by the asterisk), candidate 302 may be tagged with a bit of 1 to indicate it is final (as indicated by the asterisk), candidate 303 may be tagged with a bit of 0 to indicate it is non-final (as indicated by the plus sign), and candidate 304 may be tagged with a bit of 0 to indicate it is non-final (as indicated by the plus sign), or vice versa with respect to the bit indicators.

When decision operation 403 determines a primary entry references a final merge candidate, processing continues at operation 405, where selection of a secondary record for the shape bypassed. For example, since the primary entry references a known valid final merge candidate, a secondary record is not needed.

However, when decision operation 403 determines a primary entry references a non-final merge candidate, processing continues at operation 404, where a secondary record for the shape is selected and stored. In an embodiment, the secondary record is selected and stored without regard to whether the merge candidate the secondary record references is known to be valid, as discussed above. Notably, storing two records with reference to non-final merge candidates may provide sufficient probability that one of the merge candidates will become valid. As discussed, the secondary record is selected such that the merge candidate referenced by the primary record is not available for use in the secondary record. That is, the primary record corresponds to the lowest distortion for the shape while the secondary record corresponds to the lowest distortion for the shape that does not reference the merge candidate referenced by the primary shape (which is not necessarily the second distortion for the shape). For example, such selection and storing of primary and secondary records provides the potential for one of two non-final merge candidates to validate.

For example, with reference to FIG. 3, for shape 1, since primary record 321 references a known final merge candidate (i.e., MC-A*), in the context of process 400, secondary record 322 would not be made (e.g., selection of secondary record 322 would be bypassed). With continued reference to FIG. 3, for shape 2, since primary record 323 references a non-final merge candidate (i.e., MC-C+), secondary record 324 is selected and stored. Similarly, for shape 3, since primary record 325 references a non-final merge candidate (i.e., MC-C+), secondary record 326 is selected and stored. As discussed, in some embodiments, secondary records 324, 326 may be selected and stored using only known final merge candidates. However, in other embodiments, secondary records 324, 326 are selected and stored using any merge candidates (i.e., both final and non-final merge candidates). Although illustrated with respect to secondary records 324, 326 referencing final merge candidates (i.e., MC-A* and MC-D*, respectively), in some examples, secondary records 324, 326 reference another non-final merge candidate or candidates (i.e., MC-D+).

As shown, after operations 404, 405, processing continues at decision operation 406, where a determination is made as to whether the shape selected at operation 402 is a final available shape for processing. If not, processing continues at operations 402-406 for each shape as discussed above. If so, processing continues at operation 407, where non-final merge candidates for the block are resolved (if needed) and fractional motion estimation and final mode selection are performed. For example, with reference to FIG. 2, shared operations 411 may be performed by simultaneous integer ME module 211 to generate MERs 232, 233, 234 such that each has a single primary entry for each shape that references a known final merge candidate (e.g., if the merge candidate having the lowest distortion or cost for a particular shape is a final merge candidate, only a single primary record is stored for the shape) and multiple (e.g., two or more) entries for each shape that has a primary record that references a non-final merge candidate (e.g., if the merge candidate having the lowest distortion or cost for a particular shape is a non-final merge candidate, the primary record and one or more other records that reference different merge candidates are stored for the shape).

Thereafter, processing continues as discussed with block 141 being resolved (via fractional ME and final mode decision module 212) and informing the final merge candidates for blocks 142, 143 and MER evaluation modules 213, 216, resolution modules 214, 217, and fractional ME and final mode decision modules 215, 218 resolving blocks 142, 143 and informing the final merge candidates for block 144 and MER evaluation module 219, resolution module 220, and fractional ME and final mode decision module 221 resolving block 144, and the resultant MD and corresponding data 241, 242, 243, 244 being provided to encoder 222 to encode blocks 141, 142, 143, 144. That is, MERs 232, 233, 234 may be updated to include only final merge candidates and fractional motion estimation and mode decisions may be made with such motion estimation records.

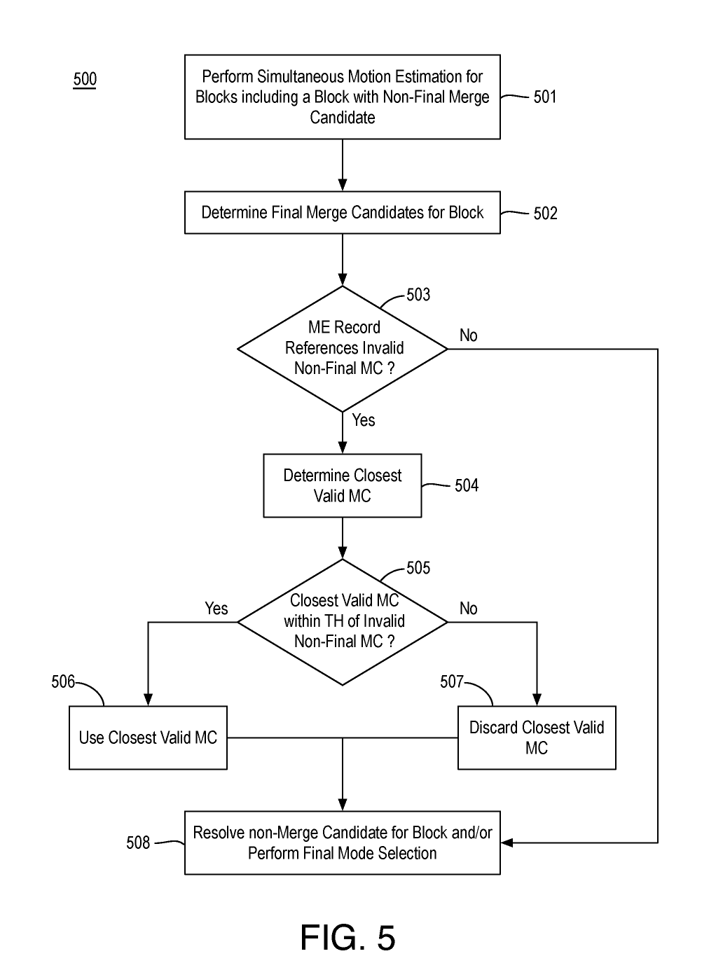

FIG. 5 is a flow diagram illustrating an example process 500 for video coding including out of loop integer motion estimation, arranged in accordance with at least some implementations of the present disclosure. Process 500 may include one or more operations 501-508 as illustrated in FIG. 5. Process 500 may be performed by a device (e.g., system 200 as discussed herein) to input video into a bitstream.

Process 500 begins at operation 501, where simultaneous motion estimation is performed by simultaneous integer ME module 211 for blocks 141, 142, 143, 144 to generate MERs 231, 232, 233, 234. Processing continues at operation 502, where final merge candidates for blocks 142, 143, 144 (block 141 used only final merge candidates) are determined as discussed herein. For example, for blocks 142, 143, resolving block 141 may determine the final merge candidates and for block 144, resolving blocks 142, 143 may determine the final merge candidates. Such resolving may be performed using fractional motion estimation and final mode decision techniques as discussed herein.

Processing continues at decision operation 503, where a determination is made as to whether, for any of blocks 142, 143, 144, a motion estimation record references an invalidated non-final merge candidate. In the context of process 500, MERs 232, 233, 234 may include only primary entries for each shape or multiple entries for each shape. Notably, if a single primary entry is used, decision operation 503 may determine whether the single primary entry references an invalidated non-final merge candidate. If multiple entries are used, decision operation 503 may determine whether all entries references invalidated non-final merge candidates. If not, processing continues at operation 508 as discussed below.

If motion estimation record(s) reference invalidated non-final merge candidates, processing continues at operation 504, where a closest valid merge candidate for the only or primary referenced merge candidate is determined. For example, with reference to FIG. 3, for primary entry 323, if no secondary entry was provided, a closest merge candidate from final merge candidates 351 to now invalidated merge candidate MC-C+ is determined. If a secondary entry was provided but also references a now invalidated merge candidate (e.g., if both MC-C+ and, for example, MC-D+ were invalidated for entries 321, 322, respectively—assuming MC-D+ in place of MC-A*), a closest merge candidate from final merge candidates 351 to now invalidated merge candidate MC-C+ is determined. Notably, a closest merge candidate to the invalidated merge candidate for the primary entry is determined in either case. However, the case with multiple entries will not evoke the processing of operations 504-507 if a secondary entry references a validated final merge candidate.

As discussed, at operation 504, a closest valid merge candidate for the only or primary referenced merge candidate is determined. The closest valid merge candidate may be determined using any suitable technique or techniques that determines the valid merge candidate that most closely matches the invalidated non-final merge candidate. In an embodiment, differences (e.g., deltas) between the invalidated non-final merge candidate and each of final merge candidates 351 is determined and the final merge candidate with the smallest difference is selected. The difference or delta may be determined using any suitable technique or techniques such as differencing the motion vectors, generating a sum of squares of the differences between the motion vectors in the x- and y-dimensions, etc.

Processing continues at decision operation, where a determination is made as to whether the closest valid merge candidate is within a threshold of the invalidated non-final merge candidate. Such a determination may be made using any suitable technique or techniques. In an embodiment, the difference or delta measure generated at operation 504 is compared to a threshold. If the difference or delta measure compares favorably to the threshold (e.g., is less than, <, or less than or equal to, ≤), the closest valid merge candidate is within a threshold of the invalidated non-final merge candidate. In an embodiment, the difference or delta measure is an absolute value of the difference between the closest valid merge candidate and the invalidated non-final merge candidate and the threshold is 2 pixels. In an embodiment, the difference or delta measure is an absolute value of the difference between the closest valid merge candidate and the invalidated non-final merge candidate and the threshold is 1.5 pixels. In an embodiment, the difference or delta measure is an absolute value of the difference between the closest valid merge candidate and the invalidated non-final merge candidate and the threshold is 1 pixel.

In an embodiment, the threshold is quantization parameter (QP) dependent such that larger QP values for the pertinent block correspond to larger threshold values. For example, the threshold may be a monotonically increasing function of the QP such that the monotonically increasing function may be a linear function or a step function. In an embodiment, the closest valid merge candidate being within a threshold of the invalidated non-final merge candidate is determined by a difference between the closest valid merge candidate and the invalidated non-final merge candidate being not more than the threshold such that the threshold is based on a QP corresponding to the block, and such that, in response to the QP being a first QP value, the threshold is a first threshold value and, in response to the QP being a second QP value, the threshold is a second threshold value greater than the first threshold value in response to the second QP value being greater than the first QP value.

As shown, in response to the closest valid merge candidate being within a threshold of the invalidated non-final merge candidate, processing continues at operation 506, where the closest valid merge candidate is used for the block and shape. That is, the entry of the MERs for that references an invalidated non-final merge candidate replaces that candidate with the closest valid merge candidate when they are within a threshold of one another. Such techniques may leverage the simultaneous motion estimation while providing a referenced merge candidate without repeated searches, etc. For example, with reference to FIG. 3, for primary entry 323, if no secondary entry was provided, a closest merge candidate from final merge candidates 351 to now invalidated merge candidate MC-C+ is determined (e.g., MC-E*). If now invalidated merge candidate MC-C+ is within a threshold of closest merge candidate MC-E*, primary entry 323 is updated to replace invalidated merge candidate MC-C+ with final merge candidate MC-E*. Similar techniques are applied of both entries 323, 324 reference now invalidated merge candidates (i.e., invalidated merge candidate MC-C+ of primary entry 323 is updated and secondary entry 324 is discarded).

If the closest valid merge candidate is not within a threshold of the invalidated non-final merge candidate, processing continues at operation 507, where the closest valid merge candidate (along with the now invalidated non-final merge candidates) are discarded. As discussed, such processing may leave a particular shape without a merge candidate. In such contexts, the shape may be re-searched or the shape may not be used in the final mode decision for the block.

As shown, processing continues from decision operation 503 (in response to ME records referencing validated non-final merge candidates), operation 506, or operation 507 at operation 508, where non-final merge candidates for the block are resolved (if needed) and fractional motion estimation and final mode selection are performed. For example, with reference to FIG. 2, operation 501 may be performed by simultaneous integer ME module 211 to generate MERs 232, 233, 234 having only one primary entry for each shape or multiple entries for each shape. Thereafter, processing continues as discussed with block 141 being resolved (via fractional ME and final mode decision module 212) and informing the final merge candidates for blocks 142, 143 to provide operation 502. MER evaluation modules 213, 216 and resolution modules 214, 217 may then perform operations 503-507 to update MERs 232, 233, which are then used by fractional ME and final mode decision modules 215, 218 to resolve blocks 142, 143, which then provides the final merge candidates for block 144. MER evaluation module 219 and resolution module 220 then perform operations 503-507 to update MERs 234 and fractional ME and final mode decision module 221 resolves block 144 as discussed, in a cascading manner. The resultant MD and corresponding data 241, 242, 243, 244 are provided to encoder 222 to encode blocks 141, 142, 143, 144 as discussed herein.

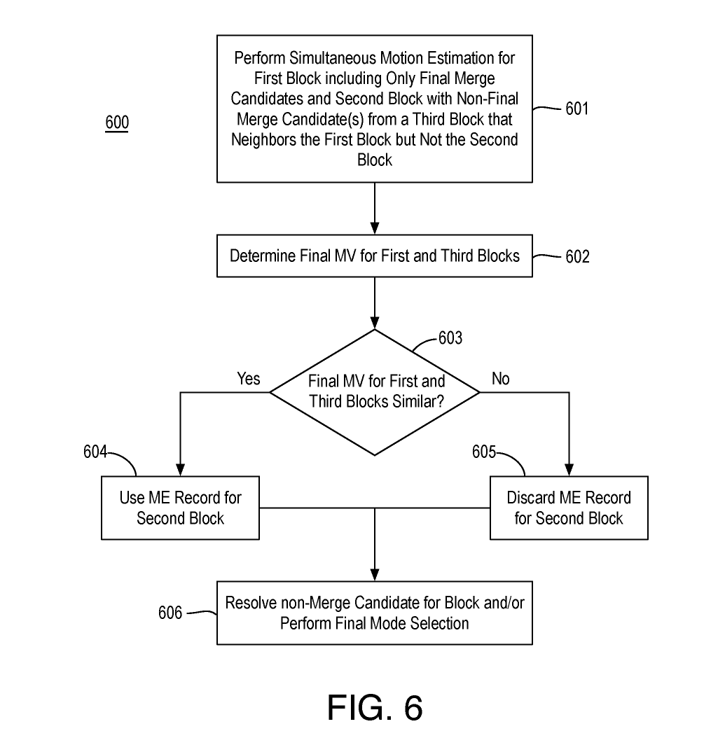

FIG. 6 is a flow diagram illustrating an example process 600 for video coding including out of loop integer motion estimation, arranged in accordance with at least some implementations of the present disclosure. Process 600 may include one or more operations 601-606 as illustrated in FIG. 6. Process 600 may be performed by a device (e.g., system 200 as discussed herein) to input video into a bitstream.

Process 600 begins at operation 601, where simultaneous motion estimation is performed by simultaneous integer ME module 211 for blocks 141, 142, 143, 144 to generate MERs 231, 232, 233, 234. Notably, the simultaneous motion estimation includes simultaneous motion estimation for block 141 (e.g., a first block), which has only final merge candidates, and blocks 142, 143, which have non-final merge candidates. As discussed, block 142 (e.g., a second block) has non-final merge candidates from block 132 (e.g., a third block), which neighbors block 141 but not block 142 and block 143 (e.g., a second block) has non-final merge candidates from block 123 (e.g., a third block), which neighbors block 141 but not block 143 (please refer to FIG. 1). In the context of process 600, simultaneous motion estimation is performed for a first block that is a block that has only final merge candidate (e.g., block 141) and a second block (e.g., block 142 and/or block 143) that is a block that has one or more non-final merge candidates from a block that is not subject to the current where simultaneous motion estimation (e.g., block 132 and/or block 123 for block 142 and/or block 143, respectively).

Processing continues at operation 602, where final motion vectors are determined for the first block (e.g., block 141) and the third block (e.g., block 132 or block 123). The final motion vectors may be determined using any suitable technique or techniques such as fractional motion estimation techniques as discussed herein. Notably, the final motion vectors for the third block (e.g., block 132 or block 123) may have been previously determined during the processing of blocks 103, 102 and those final motion vectors may be retrieved from memory. The final motion vector(s) for the first block (e.g., block 141) may be determined by fractional ME and final mode decision module 212 as discussed herein.

Processing continues at decision operation 603, where a determination is made as to whether the final motion vector(s) for the third block and the first block are similar. The determination as to whether the final motion vector(s) for the third block and the first block are similar may be made using any suitable technique or techniques. In an embodiment, a single motion vector or an average motion vector for the first block is compared to a single motion vector or an average motion vector for the third block, and if the difference or delta therebetween is less than a threshold, the final motion vector(s) for the third block and the first block are deemed to be similar.

In various embodiments, the difference or delta is determined by differencing the motion vectors, generating a sum of squares of the differences between the motion vectors in the x- and y-dimensions, etc. In an embodiment, the difference or delta is compared to a threshold and if the difference or delta measure compares favorably to the threshold the final motion vectors are deemed to be similar. In an embodiment, the difference or delta measure is an absolute value of the difference and the threshold is in the range of 1 to 2 pixels. In an embodiment, the threshold is quantization parameter (QP) dependent such that larger QP values for the pertinent block correspond to larger threshold values as discussed with respect to operation 504.

As shown, in response to the final motion vector(s) for the third block and the first block being similar, processing continues at operation 604, where any motion record for the second block (e.g., block 142 and/or block 143) that references a merge candidate from the third block (e.g., block 123 and/or block 132) is still used for the second block. That is, MERs for the block are used in their entirety for the second block. Such MERs may be subsequently modified using any suitable technique or techniques discussed herein. However, as shown with respect to operation 605, when the final motion vector(s) for the third block and the first block are not similar, any motion record for the second block (e.g., block 142 and/or block 143) that references a merge candidate from the third block (e.g., block 123 and/or block 132) is discarded.

Processing continues from operation 604 or operation 605 at operation 606, where non-final merge candidates for the block are resolved (if needed) and fractional motion estimation and final mode selection are performed. For example, with reference to FIG. 2, operation 601 may be performed by simultaneous integer ME module 211 to generate MERs 232, 233, 234, followed by processing as discussed with block 141 being resolved (via fractional ME and final mode decision module 212) and a determination as to whether the final motion vector(s) for block 141 are similar to those of block 123 and/or block 132, and the corresponding retention or discard of pertinent merge candidate records, as discussed. Fractional ME and final mode decisions are then made and the resultant MD and corresponding data 241, 242, 243, 244 are provided to encoder 222 to encode blocks 141, 142, 143, 144 as discussed herein.

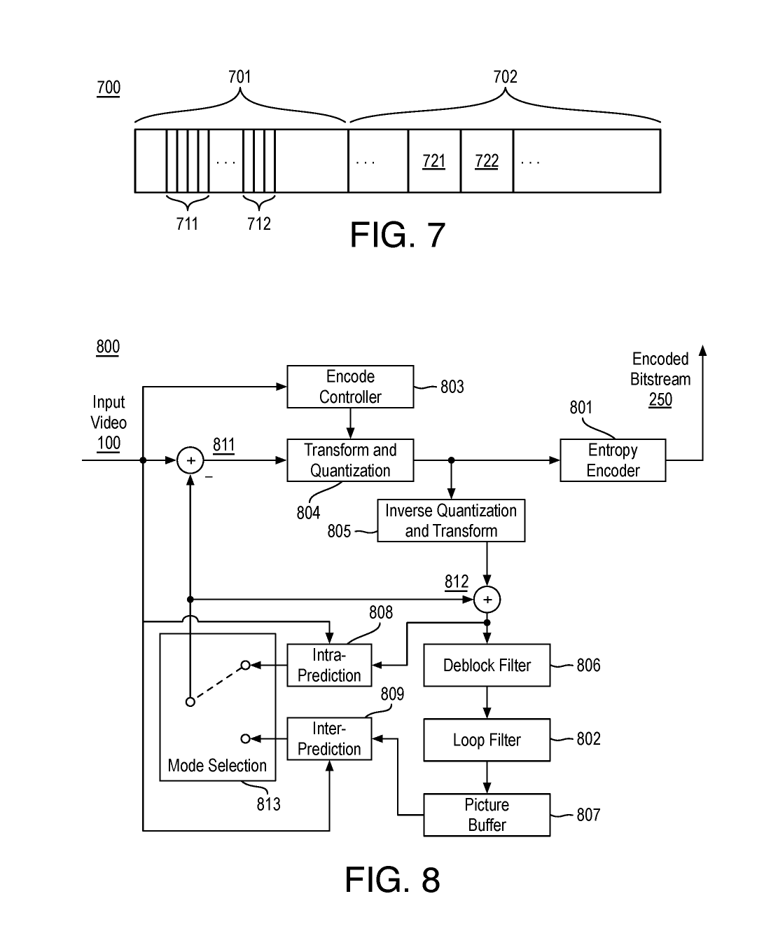

FIG. 7 illustrates an example bitstream 700, arranged in accordance with at least some implementations of the present disclosure. In some examples, bitstream 700 may correspond to bitstream 250 as shown in FIG. 2. As shown in FIG. 7, in some embodiments, bitstream 700 includes a header portion 701 and a data portion 702. Header portion 701 may include mode decision indicators 711, 712 such as block or coding unit level mode decision indicators and data corresponding to MD and corresponding data 241, 242, 243, 244. For example, mode decision indicators 711, 712 may include mode decisions and partitionings of blocks 141, 142, 143, 144. Furthermore, data portion 702 may include block data 721, 722, which may include merge candidate reference indicators, motion vector deltas, and quantized and transformed residuals for blocks 141, 142, 143, 144 and other relevant data.

FIG. 8 illustrates a block diagram of an example encoder 800 for performing out of loop motion estimation, arranged in accordance with at least some implementations of the present disclosure. As shown, encoder 800 includes an entropy encoder 801, a loop filter 802, an encode controller 803, a transform and quantization module 804, an inverse quantization and transform module 805, a deblock filter 806, a picture buffer 807, an intra-prediction module 808, and an inter-prediction module 809. Encoder 800 may include additional modules such as other modules of system 200 and/or interconnections that are not shown for the sake of clarity of presentation.

As shown in FIG. 8, encoder 800 receives picture of video 100. Picture of video 100 may be in any suitable format and may be received via any suitable technique such as video capture, fetching from memory, transmission from another device, etc. Furthermore, picture of video 100 may be processed (not shown) to determine portions of video frames (e.g., blocks, coding tree units, coding units, partitions etc.). As shown, picture of video 100 may be provided to encode controller 803, intra-prediction module 808, and inter-prediction module 809. The coupling to intra-prediction module 808 or inter-prediction module 809 may be made via mode selection module 813 as shown. For example, mode selection module 813 may make final mode decisions for portions of video frames of picture of video 100.

In some embodiments, as discussed herein, encoder 800 performs out of loop motion estimation followed by motion estimation refinement via inter-prediction module 809, encode controller 803, and other modules of encoder 800 as needed. As discussed, such out of loop motion estimation includes simultaneous motion estimation of blocks of picture of video 100 using non-final merge candidates followed by resolving those merge non-final merge candidates that were subsequently invalidated.

As shown, mode selection module 813 (e.g., via a switch), may select, for a coding unit or block or the like between a best intra-prediction mode and a best inter-prediction mode based on minimum coding cost or the like. Based on the mode selection, a predicted portion of the video frame may be differenced via differencer 811 with the original portion of the video frame (e.g., of picture of video 100) to generate a residual. The residual may be transferred to transform and quantization module 804, which may transform (e.g., via a discrete cosine transform or the like) the residual to determine transform coefficients and quantize the transform coefficients using the frame level QP discussed herein. The quantized transform coefficients may be encoded via entropy encoder 801 into encoded bitstream 250. Other data, such as motion vector residuals, modes data, transform size data, or the like may also be encoded and inserted into encoded bitstream 250 for the portion of the video frame.

Furthermore, the quantized transform coefficients may be inverse quantized and inverse transformed via inverse quantization and transform module 805 to generate a reconstructed residual. The reconstructed residual may be combined with the aforementioned predicted portion at adder 812 to form a reconstructed portion, which may be deblocked via deblock filter 806 and in-loop filtered using loop filter 802 to generate a reconstructed picture. The reconstructed picture is then saved to picture buffer 807 and used for encoding other portions of the current or other video frames. Such processing may be repeated any additional pictures of video.

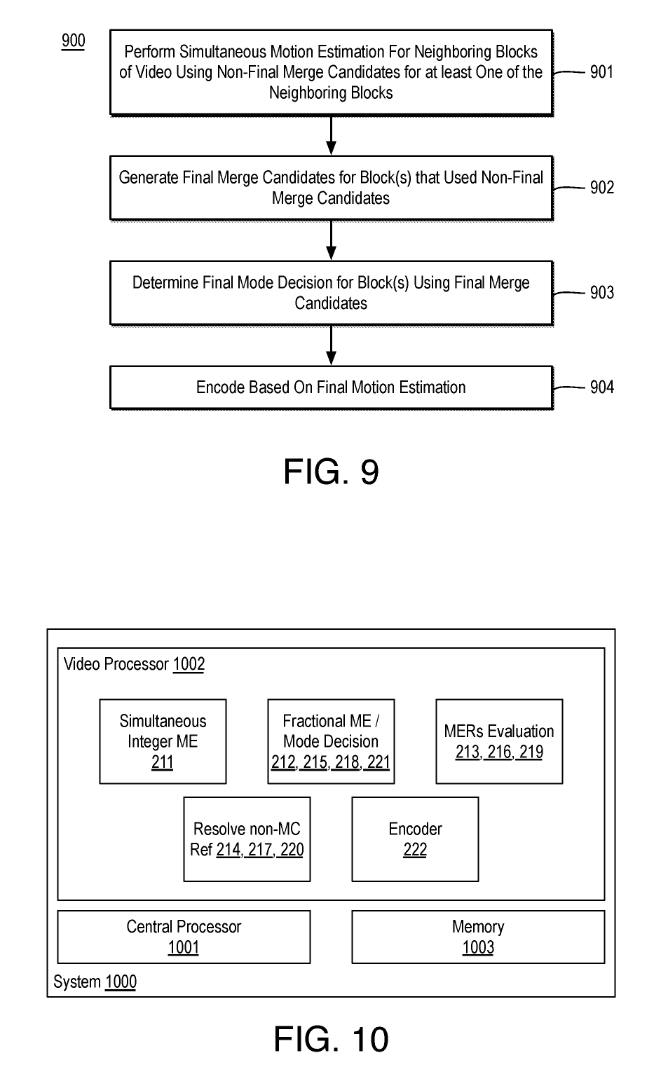

FIG. 9 is a flow diagram illustrating an example process 900 for video coding including out of loop motion estimation, arranged in accordance with at least some implementations of the present disclosure. Process 900 may include one or more operations 901-904 as illustrated in FIG. 9. Process 900 may form at least part of a video coding process. By way of non-limiting example, process 900 may form at least part of a video coding process as performed by any device or system as discussed herein such as system 100 or encoder 1200. Furthermore, process 900 will be described herein with reference to system 1000 of FIG. 10.

FIG. 10 is an illustrative diagram of an example system 1000 for video coding including out of loop motion estimation, arranged in accordance with at least some implementations of the present disclosure. As shown in FIG. 10, system 1000 may include a central processor 1001, a video processor 1002, and a memory 1003. Also as shown, video processor 1002 may include or implement simultaneous integer ME module 211, fractional ME and final mode decision modules 212, 215, 218, 221, MERs evaluation modules 213, 216, 219, resolution modules 214, 217, 220, and encoder 222. In an embodiment, memory 1003 implements picture buffer 807. Furthermore, in the example of system 1000, memory 1003 may store video data or related content such as picture data, coding unit data, merge candidate data, candidate motion vector data, motion estimation records data, final motion vector data, bitstream data, and/or any other data as discussed herein.

As shown, in some embodiments, simultaneous integer ME module 211, fractional ME and final mode decision modules 212, 215, 218, 221, MERs evaluation modules 213, 216, 219, resolution modules 214, 217, 220, and encoder 222 are implemented via video processor 1002. In other embodiments, one or more or portions of simultaneous integer ME module 211, fractional ME and final mode decision modules 212, 215, 218, 221, MERs evaluation modules 213, 216, 219, resolution modules 214, 217, 220, and encoder 222 are implemented via central processor 1001 or another processing unit such as an image processor, a graphics processor, or the like.

Video processor 1002 may include any number and type of video, image, or graphics processing units that may provide the operations as discussed herein. Such operations may be implemented via software or hardware or a combination thereof. For example, video processor 1002 may include circuitry dedicated to manipulate pictures, picture data, or the like obtained from memory 1003. Central processor 1001 may include any number and type of processing units or modules that may provide control and other high level functions for system 1000 and/or provide any operations as discussed herein. Memory 1003 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1003 may be implemented by cache memory.

In an embodiment, one or more or portions of simultaneous integer ME module 211, fractional ME and final mode decision modules 212, 215, 218, 221, MERs evaluation modules 213, 216, 219, resolution modules 214, 217, 220, and encoder 222 are implemented via an execution unit (EU). The EU may include, for example, programmable logic or circuitry such as a logic core or cores that may provide a wide array of programmable logic functions. In an embodiment, one or more or portions of simultaneous integer ME module 211, fractional ME and final mode decision modules 212, 215, 218, 221, MERs evaluation modules 213, 216, 219, resolution modules 214, 217, 220, and encoder 222 are implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 9, process 900 begins at operation 901, where, simultaneous motion estimation if performed for neighboring blocks of video using non-final merge candidates for at least one of the neighboring blocks. In an embodiment, for first and second neighboring blocks of a picture of video, simultaneous motion estimation is performed using merge candidate lists including first and second merge candidates for the first and second blocks, respectively, wherein the first merge candidates include at least a first merge candidate that is final for the first block based on a final mode decision for at a least third block that neighbors the first block but not the second block, such that the second merge candidates include at least the first merge candidate that is non-final for the second block, and such that a resultant mode decision for the second block, based on said motion estimation thereof, references the first merge candidate.

In an embodiment, performing the motion estimation for the second block includes storing a resultant motion estimation record for the second block, wherein the resultant motion estimation record comprises a lowest cost motion estimation for a particular shape of the second block, determining a second resultant motion estimation record for the second block in response to the second resultant motion estimation record being a lowest available cost motion estimation for the particular shape of the second block that does not reference the first merge candidate, and storing a second resultant motion estimation record for the second block in response to the second resultant motion estimation record being a lowest available cost motion estimation for the particular shape of the second block that does not reference the first merge candidate. That is, for any of the blocks and shapes processed at operation 901, primary and secondary motion estimation records may be stored such that the primary references a merge candidate with a lowest cost and the secondary references another merge candidate with a lowest cost that excludes the merge candidate of the primary. Such primary and secondary motion estimation records may reference merge candidates without regard to whether they are final or non-final. In an embodiment, the second resultant motion estimation record references the second merge candidate, and determining the final motion estimation for the second block includes discarding the resultant motion estimation record in response to the final merge candidates not including the first merge candidate and performing final motion estimation (as discussed with respect to operation 902) based on the second merge candidate. In an embodiment, the resultant motion estimation record includes at least a first sub-shape of the second block, the first merge candidate, and a corresponding distortion for encode of the first sub-shape using the first merge candidate. In an embodiment, the first and second neighboring blocks are coding units of a first coding tree unit, the third block is a coding unit of a second coding tree unit, and performing simultaneous motion estimation for the first and second blocks is in response to full coding mode selection completion of the second coding tree unit.

Processing continues at operation 902, where final merge candidates are generated for the blocks that used non-final merge candidates at operation 901. In an embodiment, final merge candidates are generated for the second block based on completion of final decision for the first block, such that the final merge candidates do not include the first merge candidate. As discussed, the first merge candidate being excluded from the final merge candidates requires resolution before fractional motion estimation or mode decision processing. In an embodiment, the simultaneous motion estimation consists of integer motion estimation and the final motion estimation consists of fractional motion estimation.

As discussed, in some embodiments, such resolution is provided by storing multiple records for each shape of the block. For example, any of the blocks and shapes processed at operation 901, primary, secondary, and, optionally, more motion estimation records may be stored such that the primary references a merge candidate with a lowest cost and the secondary references another merge candidate with a lowest cost that excludes the merge candidate of the primary, and so on. In an embodiment, the second resultant motion estimation record references the second merge candidate, and determining the final motion estimation for the second block includes discarding the resultant motion estimation record in response to the final merge candidates not including the first merge candidate and performing final motion estimation.

In some embodiments, process 900 further includes performing, at operation 901, for a fourth block that neighbors one of the first or second block, motion estimation simultaneous to said motion estimation of the first and second blocks using third merge candidates that comprise a non-final merge candidate and one or more second final merge candidates for the fourth block, and wherein a resultant motion estimation record for the fourth block, based on said motion estimation thereof, references the non-final merge candidate and selecting and storing, in response to the non-final merge candidate being non-final, a second motion estimation record that references one of the one or more second final merge candidate for the fourth block. That is, in some embodiments, in response to a non-final merge candidate being selected for a shape of a block, a secondary motion estimation record may be selected and stored that references a different merge candidate (which may be final or non-final).

In some embodiments, process 900 further includes performing, at operation 901, for a fourth block that neighbors one of the first or second block, motion estimation simultaneous to said motion estimation of the first and second blocks using third merge candidates that comprise a non-final merge candidate for the fourth block such that a resultant mode decision for the fourth block, based on said motion estimation thereof, references the non-final merge candidate, generating second final merge candidates for the fourth block such that the second final merge candidates do not include the non-final merge candidate, determining a third merge candidate in the second final merge candidates that most closely matches the non-final merge candidate, and using, in response to the third merge candidate being within a threshold of the non-final merge candidate, the third merge candidate for encode of the fourth block or discarding, in response to the third merge candidate not being within the threshold of the non-final merge candidate, the third merge candidate. That is, in some embodiments, when a non-final merge candidate is invalidated, a closest final merge candidate to the a non-final merge candidate may be found and, if it is within a threshold of the non-final merge candidate, it may be used for the block and shape. In an embodiment, the third merge candidate is within the threshold of the non-final merge candidate when a difference between the third merge candidate and the non-final merge candidate being not more than 2 pixels. In an embodiment, the third merge candidate is within the threshold of the non-final merge candidate when a difference between the third merge candidate and the non-final merge candidate being not more than the threshold, such that the threshold is based on a quantization parameter (QP) corresponding to the fourth block, such that, in response to the QP being a first QP value, the threshold is a first threshold value and, in response to the QP being a second QP value, the threshold is a second threshold value greater than the first threshold value in response to the second QP value being greater than the first QP value.

In some embodiments, process 900 further includes performing, for a fourth block that neighbors the first block, motion estimation simultaneous to said motion estimation of the first and second blocks using third merge candidates that comprise at least a second final merge candidate based on final motion estimation of at least a fifth block that neighbors the first block but not the fourth block to generate a second resultant mode decision for the fourth block that references the second final merge candidate, comparing a first final motion vector for the first block and a second final motion vector for the fifth block, and using, in response to the first final motion vector being within a threshold of the second final motion vector, the second resultant motion estimation record to encode the fourth block or discarding, in response to the first final motion vector not being within a threshold of the second final motion vector, the second resultant motion estimation record.

Processing continues at operation 903, where a final mode decision is determined for the blocks processed at operation 901 using resolved final merge candidates as discussed. In an embodiment, a final mode decision is determined for the second block that references a second merge candidate of the final merge candidates for the second block. For example, any merge candidate list that included non-final merge candidates may be resolved to an updated and finalized merge candidate list that includes only final merge candidates and such final merge candidates are used for final (e.g., fractional) motion estimation, mode decision, etc. for the block. Notably, such final mode decision may also reference intra modes. As discussed, process 900 resolves the motion estimation records of the processed blocks to use only final merge candidates while simultaneous motion estimation is performed using a mix of final merge candidates and non-final merge candidates.

Processing continues at operation 904, where the picture is encoded to generate a bitstream based at least in part on the final mode decisions made at operation 903 for the blocks. In an embodiment, the picture is encoded based at least in part on the final mode decision for the second block to generate a bitstream. For example, such encode may include generating reconstructed blocks corresponding to the blocks processed at operation 901 using the final motion estimation and mode decisions, differencing the reconstructed blocks from the original blocks to generate residuals, transforming and quantizing the residuals to transformed and quantized residuals and entropy encoding the transformed and quantized residuals to form a portion of the bitstream.

Process 900 may be repeated any number of times either in series or in parallel for any number of pictures or video segments or the like. As discussed, process 900 may provide for video encoding including out of loop integer motion estimation for improved coding efficiency.

Various components of the systems described herein may be implemented in software, firmware, and/or hardware and/or any combination thereof. For example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

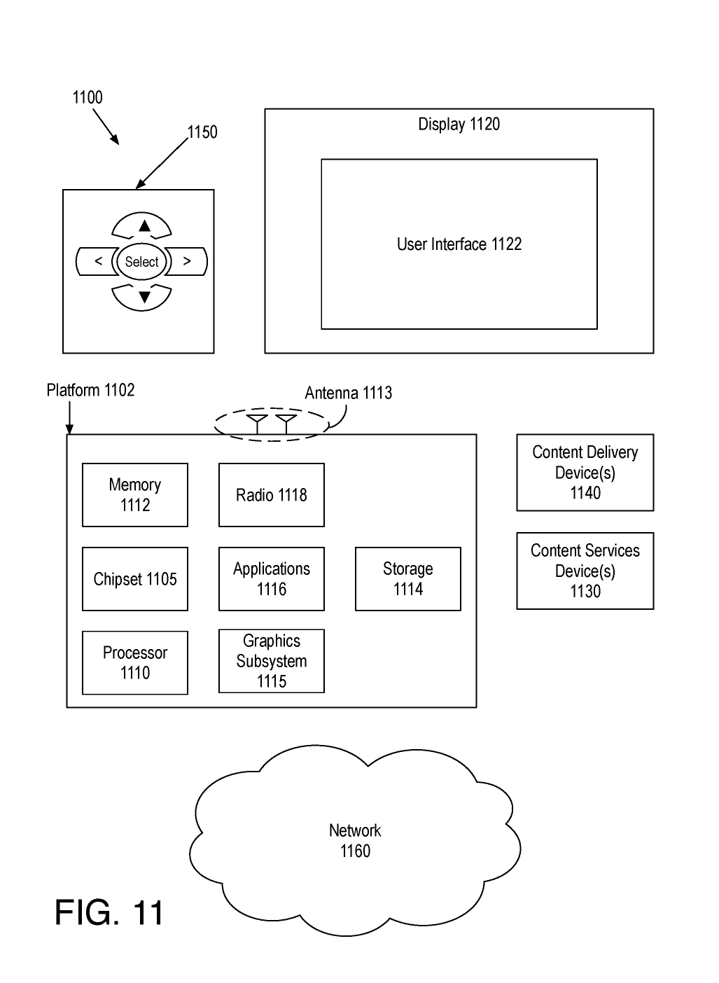

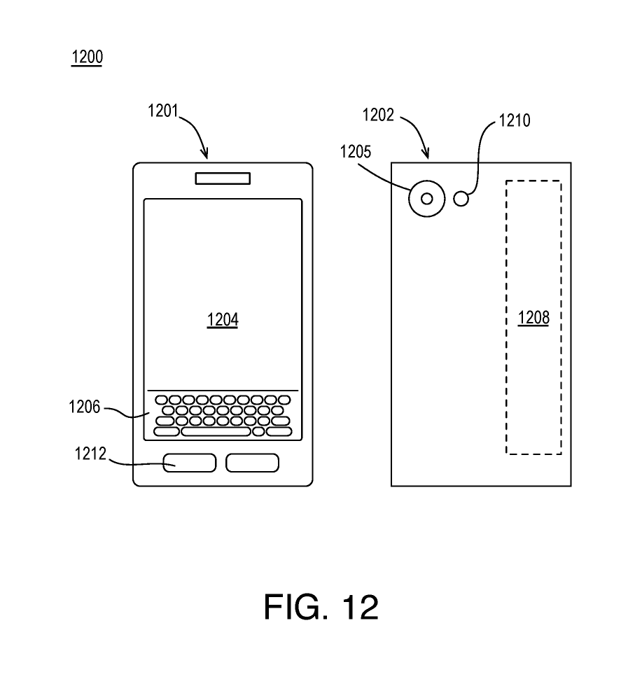

FIG. 11 is an illustrative diagram of an example system 1100, arranged in accordance with at least some implementations of the present disclosure. In various implementations, system 1100 may be a mobile system although system 1100 is not limited to this context. For example, system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1100 includes a platform 1102 coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102 and/or display 1120. Each of these components is described in greater detail below.

In various implementations, platform 1102 may include any combination of a chipset 1105, processor 1110, memory 1112, antenna 1113, storage 1114, graphics subsystem 1115, applications 1116 and/or radio 1118. Chipset 1105 may provide intercommunication among processor 1110, memory 1112, storage 1114, graphics subsystem 1115, applications 1116 and/or radio 1118. For example, chipset 1105 may include a storage adapter (not depicted) capable of providing intercommunication with storage 1114.

Processor 1110 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1114 may include technology to increase the storage performance enhanced protection for valuable digital media when multiple hard drives are included, for example.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, DisplayPort, wireless HDMI, and/or wireless HD compliant techniques. Graphics subsystem 1115 may be integrated into processor 1110 or chipset 1105. In some implementations, graphics subsystem 1115 may be a stand-alone device communicatively coupled to chipset 1105.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120. Platform 1102 and/or content services device(s) 1130 may be coupled to a network 1160 to communicate (e.g., send and/or receive) media information to and from network 1160. Content delivery device(s) 1140 also may be coupled to platform 1102 and/or to display 1120.

In various implementations, content services device(s) 1130 may include a cable television box, personal computer, network, telephone, Internet enabled devices or appliance capable of delivering digital information and/or content, and any other similar device capable of uni-directionally or bi-directionally communicating content between content providers and platform 1102 and/display 1120, via network 1160 or directly. It will be appreciated that the content may be communicated uni-directionally and/or bi-directionally to and from any one of the components in system 1100 and a content provider via network 1160. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of may be used to interact with user interface 1122, for example. In various embodiments, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1120) by movements of a pointer, cursor, focus ring, or other visual indicators displayed on the display. For example, under the control of software applications 1116, the navigation features located on navigation may be mapped to virtual navigation features displayed on user interface 1122, for example. In various embodiments, may not be a separate component but may be integrated into platform 1102 and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example. Program logic may allow platform 1102 to stream content to media adaptors or other content services device(s) 1130 or content delivery device(s) 1140 even when the platform is turned “off” In addition, chipset 1105 may include hardware and/or software support for 5.1 surround sound audio and/or high definition 7.1 surround sound audio, for example. Drivers may include a graphics driver for integrated graphics platforms. In various embodiments, the graphics driver may include a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various embodiments, platform 1102 and display 1120 may be an integrated unit. Display 1120 and content service device(s) 1130 may be integrated, or display 1120 and content delivery device(s) 1140 may be integrated, for example. These examples are not meant to limit the present disclosure.

In various embodiments, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 11.

As described above, system 1100 may be embodied in varying physical styles or form factors. FIG. 12 illustrates an example small form factor device 1200, arranged in accordance with at least some implementations of the present disclosure. In some examples, system 1100 may be implemented via device 1200. In other examples, system 100 or portions thereof may be implemented via device 1200. In various embodiments, for example, device 1200 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 12, device 1200 may include a housing with a front 1201 and a back 1202. Device 1200 includes a display 1204, an input/output (I/O) device 1206, and an integrated antenna 1208. Device 1200 also may include navigation features 1212. I/O device 1206 may include any suitable I/O device for entering information into a mobile computing device. Examples for I/O device 1206 may include an alphanumeric keyboard, a numeric keypad, a touch pad, input keys, buttons, switches, microphones, speakers, voice recognition device and software, and so forth. Information also may be entered into device 1200 by way of microphone (not shown), or may be digitized by a voice recognition device. As shown, device 1200 may include a camera 1205 (e.g., including a lens, an aperture, and an imaging sensor) and a flash 1210 integrated into back 1202 (or elsewhere) of device 1200. In other examples, camera 1205 and flash 1210 may be integrated into front 1201 of device 1200 or both front and back cameras may be provided. Camera 1205 and flash 1210 may be components of a camera module to originate image data processed into streaming video that is output to display 1204 and/or communicated remotely from device 1200 via antenna 1208 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first embodiments, a computer-implemented method for video coding comprises performing, for first and second neighboring blocks of a picture of video, simultaneous motion estimation using merge candidate lists including first and second merge candidates for the first and second blocks, respectively, wherein the first merge candidates comprise at least a first merge candidate that is final for the first block based on a final mode decision for at least a third block that neighbors the first block but not the second block, wherein the second merge candidates comprise at least the first merge candidate that is non-final for the second block, and wherein a resultant mode decision for the second block, based on said motion estimation thereof, references the first merge candidate, generating final merge candidates for the second block based on completion of final mode decision for the first block, wherein the final merge candidates do not include the first merge candidate, determining a final mode decision for the second block that references a second merge candidate of the final merge candidates for the second block, and encoding the picture based at least in part on the final mode decision for the second block to generate a bitstream.

In one or more second embodiments, further to the first embodiments, performing the motion estimation for the second block comprises storing a resultant motion estimation record for the second block, wherein the resultant motion estimation record comprises a lowest cost motion estimation for a particular shape of the second block, determining a second resultant motion estimation record for the second block in response to the second resultant motion estimation record being a lowest available cost motion estimation for the particular shape of the second block that does not reference the first merge candidate, and storing the second resultant motion estimation record for the second block.

In one or more third embodiments, further to the first or second embodiments, the second resultant motion estimation record references the second merge candidate, and wherein the processor to determine the final motion estimation for the second block comprises the processor to discard the resultant motion estimation record in response to the final merge candidates not including the first merge candidate and perform final motion estimation based on the second merge candidate.

In one or more fourth embodiments, further to the first through third embodiments, the method further comprises performing, for a fourth block that neighbors one of the first or second block, motion estimation simultaneous to said motion estimation of the first and second blocks using third merge candidates that comprise a non-final merge candidate and one or more second final merge candidates for the fourth block, and wherein a resultant motion estimation record for the fourth block, based on said motion estimation thereof, references the non-final merge candidate and selecting and storing, in response to the non-final merge candidate being non-final, a second motion estimation record that references one of the one or more second final merge candidate for the fourth block.

In one or more fifth embodiments, further to the first through fourth embodiments, the method further comprises performing, for a fourth block that neighbors one of the first or second blocks, motion estimation simultaneous to said motion estimation of the first and second blocks using third merge candidates that comprise a non-final merge candidate for the fourth block, wherein a resultant mode decision for the fourth block, based on said motion estimation thereof, references the non-final merge candidate, generating second final merge candidates for the fourth block, wherein the second final merge candidates do not include the non-final merge candidate, determining a third merge candidate in the second final merge candidates that most closely matches the non-final merge candidate, and using, in response to the third merge candidate being within a threshold of the non-final merge candidate, the third merge candidate for encode of the fourth block or discarding, in response to the third merge candidate not being within the threshold of the non-final merge candidate, the third merge candidate.

In one or more sixth embodiments, further to the first through fifth embodiments, the third merge candidate being within the threshold of the non-final merge candidate comprises a difference between the third merge candidate and the non-final merge candidate being not more than 2 pixels.

In one or more seventh embodiments, further to the first through sixth embodiments, the third merge candidate being within the threshold of the non-final merge candidate comprises a difference between the third merge candidate and the non-final merge candidate being not more than the threshold, wherein the threshold is based on a quantization parameter (QP) corresponding to the fourth block, wherein, in response to the QP being a first QP value, the threshold is a first threshold value and, in response to the QP being a second QP value, the threshold is a second threshold value greater than the first threshold value in response to the second QP value being greater than the first QP value.

In one or more eighth embodiments, further to the first through seventh embodiments, the method further comprises performing, for a fourth block that neighbors the first block, motion estimation simultaneous to said motion estimation of the first and second blocks using third merge candidates that comprise at least a second final merge candidate based on final motion estimation of at least a fifth block that neighbors the first block but not the fourth block to generate a second resultant mode decision for the fourth block that references the second final merge candidate, comparing a first final motion vector for the first block and a second final motion vector for the fifth block, and using, in response to the first final motion vector being within a threshold of the second final motion vector, the second resultant mode decision to encode the fourth block or discarding, in response to the first final motion vector not being within a threshold of the second final motion vector, the second resultant mode decision.

In one or more ninth embodiments, further to the first through eighth embodiments, the simultaneous motion estimation consists of integer motion estimation and determining the final mode decision comprises fractional motion estimation.

In one or more tenth embodiments, further to the first through ninth embodiments, the resultant mode decision comprises at least a first sub-shape of the second block, the first merge candidate, and a corresponding distortion for encode of the first sub-shape using the first merge candidate.

In one or more eleventh embodiments, further to the first through tenth embodiments, the first and second neighboring blocks comprise coding units of a first coding tree unit, the third block comprises a coding unit of a second coding tree unit, and said performing simultaneous motion estimation for the first and second blocks is in response to full coding mode selection completion of the second coding tree unit.

In one or more twelfth embodiments, a device or system includes a memory and a processor to perform a method according to any one of the above embodiments.

In one or more thirteenth embodiments, at least one machine readable medium includes a plurality of instructions that in response to being executed on a computing device, cause the computing device to perform a method according to any one of the above embodiments.

In one or more fourteenth embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A video coding system comprising:
a memory to store a picture of video; and
a processor coupled to the memory, the processor to:
perform, for first and second neighboring blocks of the picture, simultaneous motion estimation using merge candidate lists including first and second merge candidates for the first and second blocks, respectively, wherein the first merge candidates comprise at least a first merge candidate that is final for the first block based on a final mode decision for at least a third block that neighbors the first block but not the second block, wherein the second merge candidates comprise at least the first merge candidate that is non-final for the second block, and wherein a resultant mode decision for the second block, based on said motion estimation thereof, references the first merge candidate;
generate final merge candidates for the second block based on completion of final mode decision for the first block, wherein the final merge candidates do not include the first merge candidate;
determine a final mode decision for the second block that references a second merge candidate of the final merge candidates for the second block; and
encode the picture based at least in part on the final mode decision for the second block to generate a bitstream.

2. The system of claim 1, wherein the processor to perform the motion estimation for the second block comprises the processor to:
store a resultant motion estimation record for the second block, wherein the resultant motion estimation record comprises a lowest cost motion estimation for a particular shape of the second block;
determine a second resultant motion estimation record for the second block in response to the second resultant motion estimation record being a lowest available cost motion estimation for the particular shape of the second block that does not reference the first merge candidate; and
store the second resultant motion estimation record for the second block in response to the second resultant motion estimation record being a lowest available cost motion estimation for the particular shape of the second block that does not reference the first merge candidate.

3. The system of claim 2, wherein the second resultant motion estimation record references the second merge candidate, and wherein the processor to determine the final motion estimation for the second block comprises the processor to discard the resultant motion estimation record in response to the final merge candidates not including the first merge candidate and perform final motion estimation based on the second merge candidate.

4. The system of claim 1, the processor further to:
perform, for a fourth block that neighbors one of the first or second block, motion estimation simultaneous to said motion estimation of the first and second blocks using third merge candidates that comprise a non-final merge candidate and one or more second final merge candidates for the fourth block, and wherein a resultant motion estimation record for the fourth block, based on said motion estimation thereof, references the non-final merge candidate; and
select and store, in response to the non-final merge candidate being non-final, a second motion estimation record that references one of the one or more second final merge candidate for the fourth block.

5. The system of claim 1, the processor further to:
perform, for a fourth block that neighbors one of the first or second blocks, motion estimation simultaneous to said motion estimation of the first and second blocks using third merge candidates that comprise a non-final merge candidate for the fourth block, wherein a resultant mode decision for the fourth block, based on said motion estimation thereof, references the non-final merge candidate;
generate second final merge candidates for the fourth block, wherein the second final merge candidates do not include the non-final merge candidate;
determine a third merge candidate in the second final merge candidates that most closely matches the non-final merge candidate; and
use, in response to the third merge candidate being within a threshold of the non-final merge candidate, the third merge candidate for encode of the fourth block, or
discard, in response to the third merge candidate not being within the threshold of the non-final merge candidate, the third merge candidate.

6. The system of claim 5, wherein the third merge candidate being within the threshold of the non-final merge candidate comprises a difference between the third merge candidate and the non-final merge candidate being not more than 2 pixels.

7. The system of claim 5, wherein the third merge candidate being within the threshold of the non-final merge candidate comprises a difference between the third merge candidate and the non-final merge candidate being not more than the threshold, wherein the threshold is based on a quantization parameter (QP) corresponding to the fourth block, wherein, in response to the QP being a first QP value, the threshold is a first threshold value and, in response to the QP being a second QP value, the threshold is a second threshold value greater than the first threshold value in response to the second QP value being greater than the first QP value.

8. The system of claim 1, the processor further to:
perform, for a fourth block that neighbors the first block, motion estimation simultaneous to said motion estimation of the first and second blocks using third merge candidates that comprise at least a second final merge candidate based on final motion estimation of at least a fifth block that neighbors the first block but not the fourth block to generate a second resultant mode decision for the fourth block that references the second final merge candidate;
compare a first final motion vector for the first block and a second final motion vector for the fifth block; and
use, in response to the first final motion vector being within a threshold of the second final motion vector, the second resultant mode decision to encode the fourth block, or
discard, in response to the first final motion vector not being within a threshold of the second final motion vector, the second resultant mode decision.

9. The system of claim 1, wherein the simultaneous motion estimation consists of integer motion estimation and determining the final mode decision comprises fractional motion estimation.

10. The system of claim 1, wherein the resultant mode decision comprises at least a first sub-shape of the second block, the first merge candidate, and a corresponding distortion for encode of the first sub-shape using the first merge candidate.

11. The system of claim 1, wherein the first and second neighboring blocks comprise coding units of a first coding tree unit, the third block comprises a coding unit of a second coding tree unit, and said performing simultaneous motion estimation for the first and second blocks is in response to full coding mode selection completion of the second coding tree unit.

12. A computer-implemented method for video coding comprising:
performing, for first and second neighboring blocks of a picture of video, simultaneous motion estimation using merge candidate lists including first and second merge candidates for the first and second blocks, respectively, wherein the first merge candidates comprise at least a first merge candidate that is final for the first block based on a final mode decision for at least a third block that neighbors the first block but not the second block, wherein the second merge candidates comprise at least the first merge candidate that is non-final for the second block, and wherein a resultant mode decision for the second block, based on said motion estimation thereof, references the first merge candidate;
generating final merge candidates for the second block based on completion of final mode decision for the first block, wherein the final merge candidates do not include the first merge candidate;
determining a final mode decision for the second block that references a second merge candidate of the final merge candidates for the second block; and
encoding the picture based at least in part on the final mode decision for the second block to generate a bitstream.

13. The method of claim 12, wherein performing the motion estimation for the second block comprises:
storing a resultant motion estimation record for the second block, wherein the resultant motion estimation record comprises a lowest cost motion estimation for a particular shape of the second block;
determining a second resultant motion estimation record for the second block in response to the second resultant motion estimation record being a lowest available cost motion estimation for the particular shape of the second block that does not reference the first merge candidate; and
storing the second resultant motion estimation record for the second block.

14. The method of claim 13, wherein the second resultant motion estimation record references the second merge candidate, and wherein the processor to determine the final motion estimation for the second block comprises the processor to discard the resultant motion estimation record in response to the final merge candidates not including the first merge candidate and perform final motion estimation based on the second merge candidate.

15. The method of claim 12, further comprising:
performing, for a fourth block that neighbors one of the first or second block, motion estimation simultaneous to said motion estimation of the first and second blocks using third merge candidates that comprise a non-final merge candidate and one or more second final merge candidates for the fourth block, and wherein a resultant motion estimation record for the fourth block, based on said motion estimation thereof, references the non-final merge candidate; and
selecting and storing, in response to the non-final merge candidate being non-final, a second motion estimation record that references one of the one or more second final merge candidate for the fourth block.

16. The method of claim 12, further comprising:
performing, for a fourth block that neighbors one of the first or second blocks, motion estimation simultaneous to said motion estimation of the first and second blocks using third merge candidates that comprise a non-final merge candidate for the fourth block, wherein a resultant mode decision for the fourth block, based on said motion estimation thereof, references the non-final merge candidate;
generating second final merge candidates for the fourth block, wherein the second final merge candidates do not include the non-final merge candidate;
determining a third merge candidate in the second final merge candidates that most closely matches the non-final merge candidate; and
using, in response to the third merge candidate being within a threshold of the non-final merge candidate, the third merge candidate for encode of the fourth block, or
discarding, in response to the third merge candidate not being within the threshold of the non-final merge candidate, the third merge candidate.

17. The method of claim 16, wherein the third merge candidate being within the threshold of the non-final merge candidate comprises a difference between the third merge candidate and the non-final merge candidate being not more than the threshold, wherein the threshold is based on a quantization parameter (QP) corresponding to the fourth block, wherein, in response to the QP being a first QP value, the threshold is a first threshold value and, in response to the QP being a second QP value, the threshold is a second threshold value greater than the first threshold value in response to the second QP value being greater than the first QP value.

18. At least one machine readable medium comprising a plurality of instructions that, in response to being executed on a computing device, cause the computing device to perform video coding by:
performing, for first and second neighboring blocks of a picture of video, simultaneous motion estimation using merge candidate lists including first and second merge candidates for the first and second blocks, respectively, wherein the first merge candidates comprise at least a first merge candidate that is final for the first block based on a final mode decision for at least a third block that neighbors the first block but not the second block, wherein the second merge candidates comprise at least the first merge candidate that is non-final for the second block, and wherein a resultant mode decision for the second block, based on said motion estimation thereof, references the first merge candidate;
generating final merge candidates for the second block based on completion of final mode decision for the first block, wherein the final merge candidates do not include the first merge candidate;
determining a final mode decision for the second block that references a second merge candidate of the final merge candidates for the second block; and
encoding the picture based at least in part on the final mode decision for the second block to generate a bitstream.

19. The machine readable medium of claim 18, wherein performing the motion estimation for the second block comprises:
storing a resultant motion estimation record for the second block, wherein the resultant motion estimation record comprises a lowest cost motion estimation for a particular shape of the second block;
determining a second resultant motion estimation record for the second block in response to the second resultant motion estimation record being a lowest available cost motion estimation for the particular shape of the second block that does not reference the first merge candidate; and
storing the second resultant motion estimation record for the second block.

20. The machine readable medium of claim 19, wherein the second resultant motion estimation record references the second merge candidate, and wherein the processor to determine the final motion estimation for the second block comprises the processor to discard the resultant motion estimation record in response to the final merge candidates not including the first merge candidate and perform final motion estimation based on the second merge candidate.

21. The machine readable medium of claim 18, the machine readable medium further comprises a plurality of instructions that, in response to being executed on the computing device, cause the computing device to perform video coding by:
performing, for a fourth block that neighbors one of the first or second block, motion estimation simultaneous to said motion estimation of the first and second blocks using third merge candidates that comprise a non-final merge candidate and one or more second final merge candidates for the fourth block, and wherein a resultant motion estimation record for the fourth block, based on said motion estimation thereof, references the non-final merge candidate; and
selecting and storing, in response to the non-final merge candidate being non-final, a second motion estimation record that references one of the one or more second final merge candidate for the fourth block.

22. The machine readable medium of claim 18, the machine readable medium further comprises a plurality of instructions that, in response to being executed on the computing device, cause the computing device to perform video coding by:
performing, for a fourth block that neighbors one of the first or second blocks, motion estimation simultaneous to said motion estimation of the first and second blocks using third merge candidates that comprise a non-final merge candidate for the fourth block, wherein a resultant mode decision for the fourth block, based on said motion estimation thereof, references the non-final merge candidate;
generating second final merge candidates for the fourth block, wherein the second final merge candidates do not include the non-final merge candidate;
determining a third merge candidate in the second final merge candidates that most closely matches the non-final merge candidate; and
using, in response to the third merge candidate being within a threshold of the non-final merge candidate, the third merge candidate for encode of the fourth block, or
discarding, in response to the third merge candidate not being within the threshold of the non-final merge candidate, the third merge candidate.

23. The machine readable medium of claim 22, wherein the third merge candidate being within the threshold of the non-final merge candidate comprises a difference between the third merge candidate and the non-final merge candidate being not more than the threshold, wherein the threshold is based on a quantization parameter (QP) corresponding to the fourth block, wherein, in response to the QP being a first QP value, the threshold is a first threshold value and, in response to the QP being a second QP value, the threshold is a second threshold value greater than the first threshold value in response to the second QP value being greater than the first QP value.
